(19) United States
(12) Patent Application Publication
(10) Pub. No.: US 2023/0171385 A1
(43) Pub. Date: Jun. 1, 2023

(54) METHODS, SYSTEMS, AND COMPUTER READABLE MEDIA FOR HARDWARE-IN-THE-LOOP PHASE RETRIEVAL FOR HOLOGRAPHIC NEAR EYE DISPLAYS

(71) Applicants: The University of North Carolina at Chapel Hill, Chapel Hill, NC (US); The Trustees of Princeton University, Princeton, NJ (US)

(72) Inventors: Praneeth Kumar Chakravarthula, Carrboro, NC (US); Felix Heide, Princeton, NJ (US); Ethan Tseng, Princeton, NJ (US); Tarun Srivastava, North Point (HK)

(21) Appl. No.: 18/071,065

(22) Filed: Nov. 29, 2022

Related U.S. Application Data
(60) Provisional application No. 63/283,744, filed on Nov. 29, 2021.

(51) Int. Cl. H04N 9/31; H04N 9/73; H04N 9/01; H04N 13/275; H04N 13/257; G03H 1/22

(52) U.S. Cl. CPC H04N 9/3182; H04N 9/73; H04N 9/01; H04N 13/275; H04N 13/257; G03H 1/2294; G03H 2226/02

(57) ABSTRACT

A method for learned hardware-in-the-loop phase retrieval for holographic near-eye displays includes generating simulated ideal output images of a holographic display. The method further includes capturing real output images of the holographic display. The method further includes learning a mapping between the simulated ideal output images and the real output images. The method further includes using the learned mapping to solve for an aberration compensating hologram phase and using the aberration compensating hologram phase to adjust a phase pattern of a spatial light modulator of the holographic display.

### PRIORITY CLAIM

This application claims the priority benefit of U.S. Provisional Patent Application Ser. No. 63/284,744, filed Nov. 29, 2021, the disclosure of which is incorporated herein by reference in its entirety

### GOVERNMENT INTEREST

This invention was made with government support under Grant Numbers 1840131 and 1405847 awarded by the National Science Foundation. The government has certain rights in the invention.

### TECHNICAL FIELD

The subject matter described herein relates to near-eye holographic displays. More particularly, the subject matter described herein relates to holographic displays that use artificial intelligence to learn to compensate for chromatic aberrations.

### BACKGROUND

Phase only digital holography techniques involve computing a phase only hologram used to modulate the phases of pixels of a spatial light modulator (SLM) to minimize differences between a projected image, also referred to as a holographic projection, produced by passing light through the SLM, and an ideal target image. One problem with existing digital holography methods is that the light propagation model used to optimize the phase modulation of the SLM does not account for chromatic aberrations in the real image produced by non-ideal light transport through the display. Instead, the light propagation model assumes ideal light propagation through the display optics. A real display includes imperfect optics and dust particles that produce non-uniform illumination of the image plane. The non-uniform illumination is difficult to model and may be different for each display.

Accordingly, in light of these and other challenges, there exists a need for improved methods, systems, and computer readable media for digital holography.

### SUMMARY

A method for learned hardware-in-the-loop phase retrieval for holographic near-eye displays includes generating simulated ideal output images of a holographic display. The method further includes capturing real output images of the holographic display. The method further includes learning a mapping between the simulated ideal output images and the real output images. The method further includes using the learned mapping to solve for an aberration compensating hologram phase and using the aberration compensating hologram phase to adjust a phase pattern of a spatial light modulator of the holographic display.

The subject matter described herein may be implemented in software in combination with hardware and/or firmware. For example, the subject matter described herein may be implemented in software executed by a processor. In one exemplary implementation, the subject matter described herein may be implemented using a non-transitory computer readable medium having stored thereon computer executable instructions that when executed by the processor of a computer control the computer to perform steps. Exemplary non-transitory computer readable media suitable for implementing the subject matter described herein include non-transitory devices, such as disk memory devices, chip memory devices, programmable logic devices, field-programmable gate arrays, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter described herein will now be explained with reference to the accompanying drawings of which:

FIG. 1 illustrates an experimental display prototype for hardware-in-the-loop and holographic projects produced using the display prototype and other methods for digital holography. Holographic displays often show poor image quality due to severe real world deviations in the light propagation compared to the simulated “ideal” light propagation model. We built a holographic display-camera setup (left) to generate data that is used to train a neural network for approximating the unknown light propagation in a real display and the resulting aberrations. We then use this trained network to compute phase holograms that compensate for real world aberrations in a hardware-in-the-loop fashion. This allows us to supervise the display states with unknown light propagation just by observing image captures of the display prototype (left). Compared to holographic images captured using state-of-the-art methods, Double Phase Encoding [Maimone et al. 2017] (bottom center) and Wirtinger Holography [Chakravarthula et al. 2019] (bottom right), the proposed method (top right) produces images on real hardware that are aberration-free and close to the target image (top center);

FIG. 2 illustrates a representative (Fourier) holographic image formation model and its deviations on a real-world prototype. For computing the scalar diffraction integral, light from a coherent illumination source modulated by a continuous hologram aperture is simulated. Evaluating the integral for the given forward model results in the digitally propagated wave field on the image plane (top). However, the diffraction integral no longer holds in a real-world prototype where severe deviations occur due to the illumination source, imperfect optics, pixelated SLM and coherent laser speckle (bottom). Explicitly modeling and calibrating these deviations is often not feasible;

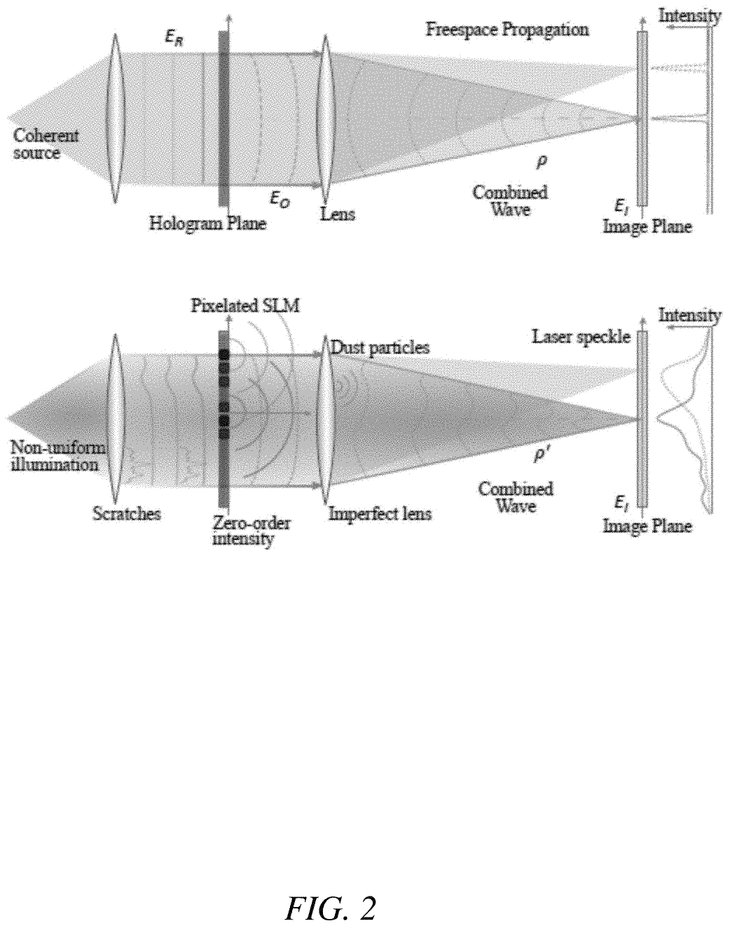

FIG. 3 illustrates an overall pipeline of our hardware-in-the-loop phase retrieval method. We compensate for real world errors in holographic image reconstruction by a hardware-in-the-loop optimization method. In contrast to existing approaches, we use a trained neural network that acts as a differentiable mapping function from the ideal simulated reconstruction to the aberrated real world display. Using this network as an approximator to the hardware, we perform a hardware-in-the-loop optimization;

FIG. 4 illustrates zero-order elimination. (A) Zero-order undiffracted light from the dead-space between SLM pixels result in a bright ringing pattern over the image that severely affects the image quality with poor contrast. (B) We eliminate the zero-order light by adding a linear phase ramp to the phase patterns and filtering the unwanted light using an iris. (C) Compared to the reference image (left), holographic projections with zero-order light show severe ringing artifacts (middle). Eliminating zero-order light improves the image contrast significantly but results in additional artifacts due to SLM modulation limitations (right). The holograms for (C) are computed using Wirtinger Holography, with a linear phase ramp added to it;

FIG. 5 illustrates a hardware-in-the-loop display-capture setup. Top: The display prototype setup to generate the training data for our aberration approximator network. Bottom: Setup schematic, with RGB lasers that are coupled into a single-mode fiber which illuminates the reflective SLM displaying the phase pattern. The modulated wave is measured using a conventional intensity camera;

FIG. 6 illustrates a qualitative comparison of different deep learning techniques for holographic aberration prediction. We compare aberration predictions using our method against state-of-the-art image mapping techniques. In addition to example outputs from each method, we show absolute error maps between each method and the target display output. All U-Net approaches fail to match the aberrations of the display. Pix2Pix is able to coarsely match the aberrations but not the color tones. Pix2PixHD learns to generate aberrations that look believable but do not match that actual display captures, which is particularly evident in the corresponding error maps. Furthermore, Pix2PixHD sometimes produces additional artefacts; an example of which can be seen in the first row. The proposed approach models the aberrations in a real holographic display with greatest fidelity;

FIG. 7 illustrates simulated results for phase retrieval using the trained aberration approximator. For a given target image (left), our aberration approximator network estimates the “aberrated” hardware display output (middle) due to real world deviations from an ideal light propagation model. We compensate for these real world deviations through our hologram optimization method. The simulated reconstructions of our holograms eliminate severe predicted aberrations and show a significant improvement in image quality (right);

FIG. 8 illustrates results from experimental validation. We computed aberration compensated phase holograms using the proposed hardware-in-the-loop approach. We captured RGB color images of these aberration compensated holograms in a color sequential manner. The same camera settings were used for all the image capture experiments while the output laser power was adjusted to white-balance the illumination. Note that the laser power was adjusted (increased) for double phase encoding holograms due to the unwanted loss of light in the double phase encoding approach;

FIG. 9 illustrates 3D holograms via dynamic global scene focus. We acquire RGB color images of 3D volumetric scenes projected at different depths via global scene focus and captured in a color sequential manner. The images were captured with the same camera settings for all the experiments, an ISO of 100 and an exposure time of 10 ms, while the output laser power was adjusted to white-balance the illumination;

FIG. 10 includes images that illustrate robustness of the proposed method to spatial, temporal and acquisition device. We evaluate the robustness of our method by acquiring and comparing the quality of images with spatial, temporal and camera variability. In specific, we evaluate the quality of measured holographic images spatially by displacing the camera up to 4 cm (top), temporally over a period of 3 months (bottom left) and with different imaging devices (bottom right). The proposed method produces consistent stable results for all setup variations. Spatial and temporal variability experiments are performed with a Canon Rebel T6i DSLR camera.

FIG. 11 is a block diagram of an exemplary system for hardware-in-the-loop phase retrieval for holographic near eye displays;

FIG. 12 is a flow chart of an exemplary process for hardware-in-the-loop phase retrieval for holographic near eye displays;

FIG. 13 illustrates improvement in image captures from a hardware prototype after removal of zero-order light;

FIG. 14 illustrates a target image of a tiger and corresponding images produced using the methodology described herein, Wirtinger holography with zero order included, and without zero order. Wirtinger holography with zero order included introduces an undesirable ringing artifact around the image. Removing the DC component reduces these ringing artifacts; however, we still find intense laser speckle throughout the image alongside global artifacts such as blue streaks that can be seen above the left eye of the tiger. The proposed method is able to significantly reduce intensity of the laser speckle and decreases the impact of the previously mentioned streaks;

FIG. 15 illustrates a target image of a rose and corresponding images produced using the methodology described herein, Wirtinger holography with DC order, and Wirtinger holography with the DC order eliminated. If we observe the flat textured regions of the petals, we find that the proposed method significantly reduces the intensity of the coherent speckle compared to other methods. In Wirtinger holography with DC component eliminated, we find large granular noisy pixels. The proposed method significantly reduces the intensity and size of such pixels. Global artifacts such as horizontal streaks are also mitigated by the proposed method;

FIG. 16 illustrates a target image of a residence and corresponding images produced using the methodology described herein, Wirtinger holography with DC order, and Wirtinger holography with the DC order eliminated. The proposed method outperforms prevailing phase retrieval methods. If we observe the center of the display capture using Wirtinger holography with DC order removed, we find several large noisy green pixels alongside visible dark lines across the scene. The proposed method mitigates these streaks and noisy green pixels. Laser speckle is reduced to a much finer resolution with a lighter intensity;

FIG. 17 illustrates a target image of a city street and corresponding images produced using the methodology described herein, Wirtinger holography with DC order, and Wirtinger holography with the DC order eliminated. The display capture for Wirtinger holography with DC order removed shows several dark lines across the image. The proposed phase retrieval method effectively removes observable instances of these lines;

FIG. 18 illustrates a target image of a building and corresponding images produced using the methodology described herein, Wirtinger holography with DC order, and Wirtinger holography with the DC order eliminated. In FIG. 18, improved texture and reduced noise can be seen in the walls and windows of the building depicted in the image generated using the proposed method;

FIG. 19 illustrates a target image of leaves and corresponding images produced using the methodology described herein, Wirtinger holography with DC order, and Wirtinger holography with the DC order eliminated. In FIG. 19, the proposed method mitigates the streak artifacts and reduces the impact of aberrations seen in the Wirtinger holography methods;

FIG. 20 illustrates a target image of a swimming pool floor and corresponding images produced using the methodology described herein, Wirtinger holography with DC order, and Wirtinger holography with the DC order eliminated. In FIG. 20, although uniform background textures like the swimming pool floor reveal some streak artifacts remaining in the images produced using the proposed method, the impact of aberration is still greatly reduced compared to the other two methods;

FIG. 21 illustrates a target image of zebras in a grassy field with trees in the background and corresponding images produced using the methodology described herein, Wirtinger holography with DC order, and

Wirtinger holography with the DC order eliminated. In FIG. 21, the streaks in the grassy field are greatly reduced with hardware-in-the-loop optimization. Aberrations found on the zebras are also reduced;

FIG. 22 illustrates a target image of the rock band Spyair and corresponding images produced using the methodology described herein, Wirtinger holography with DC order, and Wirtinger holography with the DC order eliminated. In FIG. 22, the proposed method reduces the streak aberrations which allows for better visualizations of human faces and hair textures seen in this example;

FIG. 23 illustrates a target image of a tiger and corresponding images produced using the methodology described herein, Wirtinger holography with DC order, and Wirtinger holography with the DC order eliminated. In FIG. 23, the details of the face of the tiger can be better seen after optimization with the proposed method;

FIG. 24 illustrates near and far focus images of a motorcycle and reconstructed images generated using hardware-in-the loop phase retrieval. The left hand images illustrate that after hardware-in-the loop optimization, enhanced color and sharpness in details can be seen in the captured 3D holographic display. For example, the grooves on the front wheel can be seen in the near focus case, and the bag and exhaust pipes are sharp in the far focus case;

FIG. 25 illustrates target images, images produced using hardware-in-the loop phase retrieval, and images produced using hardware-in-the loop phase retrieval with an optimized aberration approximator. FIG. 25 demonstrates that the methods described herein can be extended towards online phase optimization by refining the aberration approximator on images seen during testing. The middle column displays holographic captures after our hardware-in-the-loop optimization. The right column displays holographic captures after refining on each individual image through online optimization. Examples of improvements that can be observed include the finer curtain details for the first row and the sharper flower details in the second row. The results demonstrate the viability of this framework for online phase retrieval;

FIG. 26 illustrates tables that described the generator and discriminator network architecture. In the tables, “conv-k(a)-s(b)-IN-LRelu” represents a convolution layer with an a x a kernel window, using stride b, followed by instance normalization and a Leaky Relu (α=0.02) activation function. We use convT to denote transposed convolution. Our generator architecture is based on the U-Net architecture with substantial modifications. Our discriminator is conditioned on the same input into the generator, the ideal simulated reconstruction;

FIG. 27 illustrates training plots when training the aberration approximator with the proposed loss function. FIG. 27 illustrates that our network converges upon a good solution for predicting holographic aberrations with high performance across a number of image quality metrics;

FIG. 28 illustrates a qualitative comparison of ablated methods against the proposed method for selected aberration patches;

FIG. 29 illustrates that Without the support of the l1 loss component or the conditional input into the discriminator, we observed the network training to be more unstable and prone to encountering local minima. The left two columns shows the network making similar aberration predictions regardless of the input image and failure to learn the fine aberration differences between images. Observe that by taking the absolute difference between two different image scenes, the aberrated noise pattern is almost completely removed, indicating that the predictions are almost identical regardless of the input scene. In contrast, taking the same difference between the targets shows many differences even in the aberration noise patterns. Our proposed method avoids this local minima as shown in the second column from the right, as both the predicted aberrations and the absolute difference map match the target's;

FIG. 30 illustrates a comparison of different baseline methods and proposed method for the Aberration Approximator. The U-Net approaches fail to learn the diverse aberration patterns. Pix2Pix is better but makes many mistakes as can be seen in the error maps. Pix2PixHD is similar but also hallucinates additional artifacts, an example of which can be seen in the first row;

FIG. 31 illustrates a comparison of different baseline methods and the proposed method for the Aberration Approximator. The U-Net approaches fail to learn the diverse aberration patterns. Examples of mistakes made by Pix2Pix can be seen in the first row where the letters are not sufficiently aberrated and the fourth row where the color tones do not accurately match the display. The error maps for Pix2PixHD reveal many aberration prediction mismatches despite the believable predictions at first glance; and

FIG. 32 illustrates, from left to right, the reference image, estimated display output as predicted by the aberration approximator network and the reconstruction of the optimized aberration-compensating hologram as generated by the proposed method. This figure provides additional results to those illustrated in FIG. 7.

### DETAILED DESCRIPTION

Holography is arguably the most promising technology to provide wide field-of-view compact eyeglasses-style near-eye displays for augmented and virtual reality. However, the image quality of existing holographic displays is far from that of current generation conventional displays, effectively making today's holographic display systems impractical. This gap stems predominantly from the severe deviations in the idealized approximations of the “unknown” light transport model in a real holographic display used for computing holograms.

In this work, we depart from such approximate “ideal” coherent light transport models for computing holograms. Instead, we learn the deviations of the real display from the ideal light transport from the images measured using a display-camera hardware system. After this unknown light propagation is learned, we use it to compensate for severe aberrations in real holographic imagery. The proposed hardware-in-the-loop approach is robust to spatial, temporal and hardware deviations and improves the image quality of existing methods qualitatively and quantitatively in SNR and perceptual quality. We validate our approach on a holographic display prototype and show that the method can fully compensate for unknown aberrations and erroneous and non-linear SLM phase delays, without explicitly modeling them. As a result, the proposed method significantly outperforms existing state-of-the-art methods in simulation and experimentation—just by observing captured holographic images.

### 1 Introduction

Personal displays play an essential role in how we interact with smart devices and the immediate environment, including diverse applications in communication, entertainment, medical assistance, navigation, and in emerging environments, such as self-driving vehicles. As an emerging next personal computing and social interaction platform, virtual reality (VR) and augmented reality (AR) promise such applications. Indeed, existing consumer products offer wearable displays with an acceptable form factor, resolution and field of view, which make a wide variety of compelling applications in VR possible. However, AR displays still remain limited to large hardware, suffer from low image quality, vergence-accommodation conflict, and they do not allow for occlusion effects. Overcoming these limitations using conventional optics results in large setups. Resorting to approaches such as light field displays promises compact form factors, but is a poor alternative due to the spatio-angular resolution trade-off. For near-eye displays to be widely adopted as a personal and social computing platform, tomorrow's displays must provide wide field of view and high resolution in a small form factor, closely mimicking ordinary pairs of eyeglasses a user can wear for long hours.

Holographic displays, in principle, promise such an eyeglasses-like form factor by shifting the optical complexity to computation. Unlike conventional displays, which need a cascade of refractive optics to physically modulate the emitted wavefront of light, a holographic display produces this combined effect via a digital hologram using a spatial light modulator (SLM). In other words, today's holographic display methods move the complexity of traditional optics to complexity of the modulation setup and careful regularization. While theoretically an elegant and promising technology, holographic setups, in practice, suffer from severe non-linearities in the phase modulation, inhomogeneity of the SLM itself, and imperfections in the minimal optics and illumination setup.

Recent works have achieved impressive results by careful hand-tuning of these non-linearities [Maimone et al. 2017] in a light-weight wearable form-factor. However, the achieved image quality still does not approach conventional displays. An underlying fundamental limitation of the existing methods is the approximation of the light propagation model, which is generally inadequate in describing the experimental setup. Moreover, the forward models are often deliberately simplified with various assumptions and approximations to make the underlying phase retrieval problem tractable.

In this work, we depart from such approximate forward models and propose a hardware-in-the-loop method to learn the non-linear image formation model of a real holographic projection system. Relying on an initial phase estimate computed from an approximate forward model that does not consider the hardware non-linearities, we learn the mapping between the image generated by the holographic projector with unknown light transport and the intended ideal reconstruction. These mappings serve as upper bounds on the unknown objective function (and our forward model) that we aim to minimize. We validate the proposed method both in simulation and on an experimental prototype and demonstrate that our improved approach eliminates severe artifacts present in existing approaches. We assess these capabilities qualitatively and quantitatively on representative test data, and we verify that the proposed method generalizes and is robust to hardware, spatial and temporal drift.

In particular, we make the following contributions:

We introduce a method for the estimation of unknown light propagation models in holographic display forward models.

The proposed approach relies on a learned hardware-in-the-loop optimization which iteratively refines an upper bound on the estimated objective function derived in this work.

We validate the proposed method by solving phase retrieval for holographic projections with constant focus over the image. The resulting holographic reconstructions improve by more than 10 dB in simulation and 2.5 dB in PSNR on the hardware prototype.

We assess the proposed framework experimentally with a prototype near-eye holographic display setup. The proposed method reduces severe artifacts of existing holographic display approaches, which we quantify with perceptual and SNR metrics.

Overview of Limitations. Although the proposed method achieves unparalleled image quality and predicts real-world aberrations at real-time frame rates, applying the method may require end-of-manufacturing-line per-device training data to account for optical fabrication tolerances. However, this would only be a one-time calibration step which we envision to be automated for production of future holographic eyeglasses-style displays and automotive heads-up displays. Similar to aberration calibration for smartphone camera modules manufacturing, this process would require a custom display and capture stage after the fabrication of each device with the proposed hardware-in-the-loop optimization method, producing a learned aberration approximation network that might be embedded in the firmware of the device. While the proposed method may have the potential to generalize per device type, evaluating this potential capability would require access to production samples with representative tolerances.

### 2 Related Work

In this section, we review relevant holographic display technologies and computer-generated holography (CGH) algorithms.

### 2.1 Holographic Near-Eye Displays

Holographic displays have been explored as elegant approaches to variable focus control and aberration correction, which are essential features for eyeglasses-style displays. Several recent near-eye display designs employ holographic projectors and/or holographic optical elements (HOE) to achieve a compact form factor. While most of the designs rely on a single phase-only spatial light modulator (SLM) [Chen and Chu 2015], configurations using two phase SLMs [Levin et al. 2016], or a combination of both amplitude and phase SLMs [Shi et al. 2017] have also been explored. Although the proposed holographic benchtop prototypes are large and bulky, many recent works have proposed ways forward to achieve compact form factors. For example, multi-functional HOEs [Jang et al. 2019; Li et al. 2016; Maimone et al. 2017] and waveguides [Yeom et al. 2015] have been explored as techniques that allow relaying the projected imagery into the eye. Two critical limitations of existing holographic near-eye displays are the tiny eyebox and poor image quality. Several recent works have achieved an increased eyebox size by using eyetracking [Jang et al. 2019, 2017]. Eyetracking has also been proposed for focus control and aberration correction [Maimone et al. 2017].

These existing display designs merely differ in hardware implementation details such as the approaches used for optical path folding, eyetracking and component design. In contrast, the algorithms used for generating the holograms, which restrict the achievable image quality, remain the same or similar across the displays—low image quality remains a critical limitation of today's holographic displays.

### 2.2 Holographic Display Setups and Limitations

In this section we briefly review holographic display configurations and the most important limitations that restrict image quality in holographic displays.

SLM technology. Achieving accurate, complex modulation of both phase and amplitude with a single device remains an open problem [Reichelt et al. 2012]. In recent work, phase-only SLMs are often preferred due to their higher diffraction efficiency. However, these phase-only SLMs require a trillion sub-wavelength sized pixels to display holograms comparable to conventional holograms [Reichelt et al. 2012]. Unfortunately, existing SLMs only have resolutions ranging up to 3840×2160 (4K UHD) with pixel pitches limited to approximately 4 μm and fill factors less than 95%. The space for electronics between the active pixel areas further leads to zero-order undiffracted light which often causes severe artifacts in the holographic images.

Phase wrapping and quantization errors. Existing SLMs implement quantized phase modulation with limited bit-depth. Typically the phase values of the computer generated digital hologram are wrapped to lie within [0, 2π], and are further quantized to the bit-depth of the SLM. The resulting approximation errors introduced by phase wrapping and quantization significantly deteriorate the holographic image quality [Dallas and Lohmann 1972]. Furthermore, the phase modulation and diffraction efficiency of the SLM pixels are dependent on voltage controlled birefringence made available via a calibrated lookup table (LUT). Any inconsistencies in the LUTs cause non-linear phase modulation which further degrade the display quality.

Coherent Laser Speckle. Coherent light sources such as single-longitudinal-mode lasers are sources whose coherence length is large. These sources produce coherent speckle noise. Recent work aims at reducing speckle by using rotating diffusers [Bianco et al. 2016], modulating or quickly repositioning the laser beam [Kang 2008] or superposition of multiple reconstructions [Golan and Shoham 2009] Coherent laser speckle noise can also be mitigated by using partially coherent light sources; however, this results in blur or loss of depth perception due to reduced coherence length [Dainty 1977]. Although many techniques have been proposed to reduce noise in CGH [Bianco et al. 2018], effective holographic noise suppression still remains an open problem.

### 2.3 CGH Phase Retrieval Algorithms

Holography for displays relies on diffraction and interference of light for generating imagery. Based on the diffracted field, a hologram can be classified as a far-field Fourier hologram or a near-field Fresnel hologram. Using a phase-only SLM requires computing phase-only holograms that are capable of producing the diffraction field that can closely mimic the target image. This phase retrieval problem is generally ill-posed and non-convex. Though introduced for Fourier phase retrieval, early methods such as error reduction using iterative optimization [Gerchberg 1972, Lesem et al. 1969] and hybrid input-output (HIO) methods [Baushke et al. 2003; Fienup 1982] are applicable for both Fourier and Fresnel holograms. Researchers have also explored phase-retrieval methods using first-order non-linear optimization [Fienup 1993; Gonsalves 1976; Lane 1991], alternative direction methods for phase retrieval [Marchesini et al. 2016; Wen et al. 2012], non-convex optimization [Zhang et al. 2017], and methods overcoming the non-convex nature of the phase retrieval problem by lifting, i.e. relaxation, to a semidefinite [Candes et al. 2013] or linear program [Bahamani and Romberg 2017; Goldstein and Studer 2018]. Recently, Chakravarthula et al. [2019; 2020] demonstrated an optimization approach using first-order gradient descent methods to solve for holograms with flexible loss functions. We refer the reader to Barbastathis et al. [2019] for an overview of learned phase retrieval methods.

All of these methods and the following algorithms, have in common the fact that they assume a perfect image formation model and ignore deviations from the perfect forward model and non-linearities that occur in the real hardware prototype. The proposed method addresses this limitation.

Point and Polygonal Algorithms. Successful scene representations in computer graphics model a scene as a collection of points (3D point cloud), an RGB-D image, a polygonal mesh or stacked layers of intensity modulation. Researchers have leveraged such scene representation for computing holograms [Leseberg and Frere 1988; Waters 1966], popularly known as Fresnel holograms. While iterative phase retrieval methods can be applied for computing Fresnel holograms, direct methods in combination with some form of amplitude-phase encoding are much faster. One can also use a look-up table of precomputed elemental fringes to speed up the computation. Recent point-source based CGH computation methods leverage the parallelization of modern GPUs [Chen and Wilkinson 2009; Masuda et al. 2006; Petz and Magnor 2003]. Instead of computing the wave propagation for millions of points, a 3D object can be represented as a collection of tilted and shifted planes (polygonal mesh), whose diffraction patterns can be computed by the fast Fourier transform (FFT) algorithm [Matsushima 2005; Tommasi and Bianco 1993], also considering texture and shading [Ahrenberg et al. 2008; Matsushima 2005], which is not possible with the point-based hologram computation. Occlusion culling effects can also be provided using geometric facet selection by ray tracing [Kim et al. 2008], silhouette methods [Matsushima and Nakahara 2009; Matsushima et al. 2014] and inverse orthographic projection techniques (Jia et al. 2014) These methods, however, do not support subtle view-dependent effects such as intra-pupil occlusion.

Hogel-based Algorithms. A hologram can be partitioned spatially into elementary hologram patches (hogels), each producing local ray distributions (images) that together reconstruct multiple views supporting intra-ocular occlusions [Lucente and Galyean 1995, Smithwick et al. 2010; Yamaguchi et al. 1993], similar to light field displays [Lanman and Luebke 2013]. These holograms which encode a light field are dubbed “holographic stereograms”. Although conventional stereograms suffer lack of focus cues and limited depth of field [Lucente and Gaylean 1995], holographic stereograms can be paired with point-source methods to enhance the image fidelity to provide improved resolution, accommodation and occlusion cues [Shi et al. 2017; Zhang et al. 2015]. Such light field holograms typically require choosing a specific hogel size, which, in turn, requires trading off spatial and angular resolution. An overlap-add approach was recently proposed to overcome this spatio-angular resolution tradeoff, making more efficient use of information encoded in the light field [Padmanaban et al. 2019].

In contrast to light field based holograms, a further line of research proposes to slice objects at multiple depths and superimpose the wavefronts from each slice on the hologram plane [Bayraktar and Ozcan 2010; Zhao et al. 2015], similar to layer-based light field displays [Wetzstein et al. 2012]. Moreover, layer-based and light field methods can both be combined to produce view-dependent occlusion effects [Chen and Chu 2015; Zhang et al. 2016]. The proposed hardware-in-the-loop phase retrieval naturally facilitates layer-based displays due to their similarity in formulating an image loss function, in contrast to hogel-based display which requires explicitly incorporating depth in the loss for computing the holograms.

### 3 Computational Display Holography

Computational display holography aims to replace a real static hologram with a spatial light modulator (SLM) whose states are configurable. To this end, existing methods simulate the process of optical recording and reconstruction of the real hologram using numerical methods. Computing digital holograms can be interpreted as a coherent optical system producing a complex wave field, which is an image of the wave field originally reflected or refracted by the object. Generating such digital holograms for an SLM is possible as long as the sampling theorem is fulfilled: at least two pixels of the SLM sample a fringe period of the hologram. Owing to the limitations in existing SLM modulation, we focus on phase-only holograms in this work which have higher diffraction efficiency. Moreover, we adopt a Fresnel holography regime relevant to near-eye displays [Maimone et al. 2017], although the proposed method is not limited to Fresnel holography configurations.

For a hologram of complex amplitude H(ζ, η) illuminated by a reference wave field E_{R}(ζ, η), the resulting field in the image plane at a distance d can be calculated using the scalar (Fresnel) diffraction integral:

$${E}_{I} ( x , y ) = \frac{1}{j λ} {{\int }_{- ∞}}^{∞} {{\int }_{- ∞}}^{∞} H ( ζ , η ) {E}_{R} ( ζ , η ) \frac{exp ( jk ρ )}{ρ} d ζ d η , \qquad ( 1 )$$

where (ζ, η) are the coordinates on the hologram plane, (x, y) are the coordinates on the image plane,

$$k = \frac{2 π}{λ}$$

is the wave number and ρ=\sqrt{(ζ−x)²+(η−y)²+d²} is the Euclidean distance between the points on the hologram and image planes, respectively. The resulting complex wave field represents the reconstructed wave field on the image plane, containing both amplitude and phase. Note that a phase-only hologram modulates only the phase of light, and hence has a constant amplitude across the hologram plane H(ζ, η)=cexp(jΦ(ζ, η)) where c is the constant amplitude, which we assume to be unity in the following.

The diffraction integral in Eq. (1) can also be viewed as a superposition integral of waves, thus representing a linear shift-invariant system which can be written as a convolution

E_{I}(x, y)=∫_{-∞}^{∞}∫_{-∞}^{∞}H(ζ, η)E_{R}(ζ, η)·g(x−ζ, y−η)dζdη, (2)

where the kernel

$$g ( ζ , η ) = \frac{1}{j λ} \frac{exp [ jk \sqrt{{d}^{2} + {ζ}^{2} + {η}^{2}} ]}{\sqrt{{d}^{2} + {ζ}^{2} + {η}^{2}}} \qquad ( 3 )$$

is the impulse response of free space propagation. This definition is the point-source propagation model from Chakravarthula et al. Note that generating the hologram is exactly the inverse process, i.e. propagating the wave field from the image plane to the hologram plane, or equivalently, convolving the conjugate kernel with the image field. One can invoke the convolution theorem to express Eq. (2) as

E_{I}=(H·E_{R})*g= [symbol] ⁻¹( [symbol] [H·E_{R}]· [symbol] [g]) (4)

where · is the Hadamard element-wise product and [symbol] is the Fourier transform operator. The above convolution model from Eq. (4) can be reformulated to reflect Fresnel, Fraunhofer, and angular spectrum propagation by modifying the kernel g with necessary approximations. For these propagation models, please refer to the section below labeled Supplementary Material.

While the above formulation allows for synthesizing phase-only digital holograms, it assumes a continuous hologram aperture and an aberration free-hardware optical system, all simulated on a computer. However, a real hardware prototype severely deviates from ideal coherent light transport. Next, we discuss several deviations which affect the final holographic image quality, building towards the underlying non-ideal coherent light transport for a phase-only holographic display.

### 3.1 SLM Fill Factor

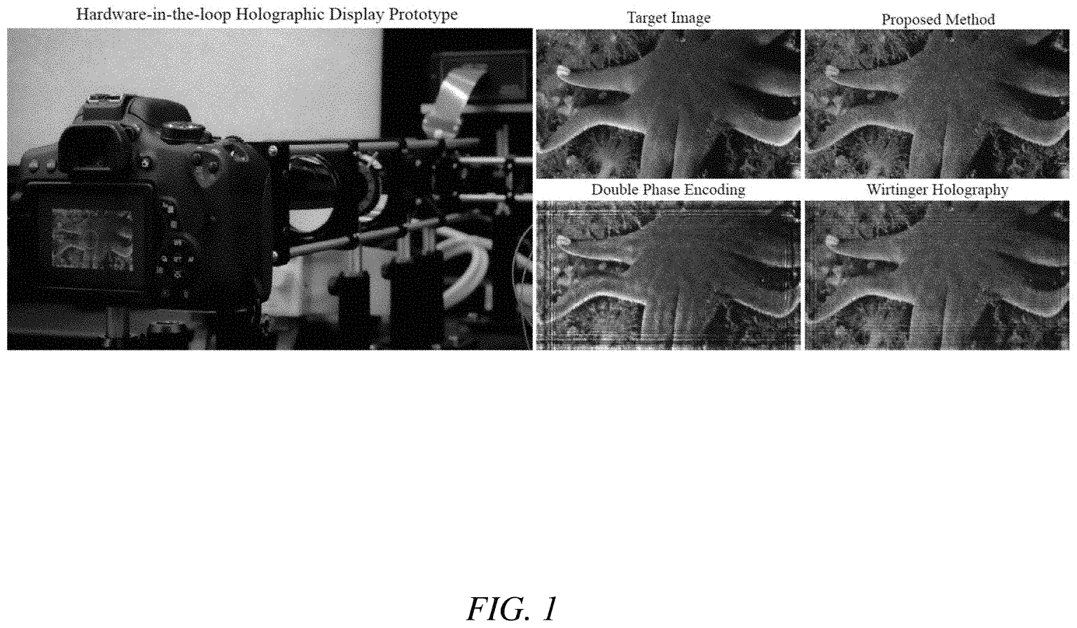

In contrast to a continuous aperture assumed in the scalar diffraction integral, an SLM is discretized into pixels. For a theoretical fill factor of 100% of the SLM, the pixel size equals the pixel pitch, and the SLM would act as a continuous aperture. However, existing SLMs in CMOS technology contain small non-modulating zones between the individual phase modulating pixels, limiting the fill factor. As shown in FIG. 1, we can characterize such physical SLMs by the number of pixels N and M in ζ and η directions, respectively with the pixel pitches Δζ and Δη and with fill factors in the range [0,1]. The transmittance of such an SLM can be modeled as follows:

$${t}_{SLM} = rect ( \frac{ζ}{N Δ ζ} , \frac{η}{M Δη} ) [ {t}_{ap} + {t}_{ds} ] , \qquad ( 5 )$$

where tₐₚ is the transmission function of the active pixel area displaying the phase pattern of the computed phase-only hologram, t_{ds} is the transmission of the dead space area of the SLM pixels, and

$$rect ( \frac{ζ}{N Δ ζ} , \frac{η}{M Δ η} )$$

is the total SLM aperture area. Please refer to the Supplementary Material section for details. Inspecting Eq. (5), it becomes clear that the SLM introduces an extra complex amplitude to the hologram, which typically shows up as a zero-order intensity overlay, significantly distorting the reconstructed image pattern.

### 3.2 Non-Linear SLM, Phase Wrapping and Quantization

As discussed in Section 2, the phase modulation of an SLM is controlled by a voltage that is represented by a gray level. The mapping between gray levels and voltage levels can be non-linear and is typically represented by a Lookup Table (LUT). Approximation errors in this LUT result in erroneous phase modulations. Moreover, wrapping the phase from 2π back to 0 and the further phase quantization into (often only 8-bit) gray levels causes quantization noise manifesting as severe aberrations. Such errors resulting from the SLM non-linearities and phase representation can be modeled as:

Φ′_{cdh}=Φ_{cdh}+Δϕₙₒₙ₋ₗᵢₙ+Δϕ_{wrap}+Δϕ_{quant}, tm (6)

where Φ_{cdh} is the computed display hologram phase pattern from an ideal light transport model, whereas Φ′_{cdh} is the represented phase pattern on the SLM effected by deviations due to non-linearities in LUT (Δϕₙₒₙ₋ₗᵢₙ), phase wrapping (Δϕ_{wrap}) and quantization (Δϕ_{quant}) 1 errors.

### 3.3 Illumination, Optics and Alignment Errors

A typical digital hologram, when illuminated by a real reference wave, eliminates the reference wave component from the hologram, leaving only the object wave, which forms the image field. However, the illuminating reference wave often cannot be accurately replicated in simulation. Furthermore, inconsistencies in the angle between the real and digital reference waves result in tilt phase errors. Such deviations can occur due to misalignment of the SLM and several reflective and/or refractive optics in the display setup. We express them as

Hᵢₗₗᵤₘ=H·A_{err;illum}exp(jϕ_{err;illum}), (7)

where A_{err;illum} and ϕ_{err,illum} model the deviations in amplitude and phase.
3.4 Phase Aberrations from Model Approximations

Evaluating a full Fresnel integral (Eq. (1)) is desirable but is often computationally expensive. Relying on Fresnel or Fraunhofer approximations instead to compute digital holograms at reasonably large distances significantly reduces the computational cost and has been proposed before . The approximation errors with respect to the full Fresnel integral cause phase aberrations (ϕ_{err;phs}) that can be modeled as

H_{err;phs}=H·exp(jϕ_{err;phs}). (8)

Such phase aberrations can result in curvatures in the reconstructed images. For example, a Fresnel approximation results in a parabolic phase error.

### 3.5 Coherent Noise

A coherent source of light impinging on an SLM also results in coherent noise, which can manifest itself as blur or grainy speckle. Any reflections within the holographic display setup cause grainy coherent speckle noise due to optically rough surfaces. Non-diffusing transparent objects introduce coherent noise from undesired diffraction and multiple reflections due to dust particles, scratches and defects in and on the optical elements. While such errors are challenging to model, their effect on the wave propagation and ideal holographic image formation can be described by the deviation in the computed hologram as

H_{err;Cnoise}=H·A_{Cnoise}exp(lϕ_{Cnoise}), (9)

where A_{Cnoise} and ϕ_{Cnoise} are the amplitude and phase of the coherent noise, respectively.

This behavior may result in severe deviations from the ideal coherent light transport from Eq. (1). As the sum and product of complex exponentials is another complex exponential, the effect of all the deviations in a real physical setup can be combined into a single complex exponential describing the aberration wave field Eₑᵣᵣ=Aₑᵣᵣexp(jϕₑᵣᵣ)

### 4. Hardware-in-the-Loop In-exact Phase Retrieval

In this section, we describe the proposed holographic phase retrieval method which incorporates hardware deviations from the ideal image formation. We start by modeling the unknown coherent light transport of a hologram as a function of the propagated wave field on the image plane. We derive an upper bound of the deviations from the ideal light transport (Eq. (1)) and represent this bound by a differentiable learned aberration approximator parameterized by a deep neural network. This formulation allows us to cast the holographic computation as a complex non-convex optimization problem, which we solve using a first-order optimization method (Chakravarthula et al. 2019]. We iteratively refine the aberration approximator in the region around the optimum via hardware-in-the-loop display captures. Once learned, the aberration approximator can be used for all future hologram calculations.

### 4.1 Compensating Phase Patterns

Expressing a complex hologram as a phase-only hologram, the conjugate complex amplitude of all deviations described in the previous section can be consumed into the computed hologram phase pattern as a compensating phase perturbation Φ_{dev}, i.e. H′=exp(j[Φ(ζ, η)+Φ_{dev}(ζ, η)]). This allows us to reformulate the light transport as

$${E}_{I}^{′} ( x , y ) = \frac{1}{j λ} {{\int }_{- ∞}}^{∞} {{\int }_{- ∞}}^{∞} {H}^{′} ( ζ , η ) {E}_{R} ( ζ , η ) {E}_{err} ( ζ , η ) \frac{exp ( j k ρ )}{ρ} d ζ d η \qquad ( 10 )$$

where H′(ζ, η) is the phase-only hologram with compensating phase for setup deviations errors, i.e. Eₑᵣᵣ introduced in Section 3. In this work, we propose a method to efficiently estimate these model deviations and compute the compensating phase patterns.

### 4.2 Inexact Phase Retrieval

Consider a phase hologram H(Φ) that is propagated using an ideal wave propagation function [symbol] . This propagation results in an observed image wave field given by E_{I}= [symbol] (H(Φ)). However, in practice, the propagation in a real-world holographic display may deviate significantly from the ideal propagation model, see Eq. (10). The resulting image wave field, taking into account both the systemic and content-dependent deviations (Eₑᵣᵣ), can be defined as

E′_{I}= [symbol] (exp(jΦ)), (11)

where [symbol] is the deviated light propagation. To design a hologram, we penalize the distance between the reconstructed intensity image Ĩ(Φ)=|E′_{I}(Φ)|² and target image I as described by a custom penalty function. For example, for an [symbol] ₂ distance, the penalty would be

$${Φ}_{OPT} = \begin{matrix}minimize \\ Φ\end{matrix} {‖ \tilde{I} ( Φ ) - I ‖}^{2} \qquad ( 12 )$$

Alternatively, we can formulate the wave field on the image plane (Eq. (11)) as a combination of the ideal non-deviated field [symbol] (H(Φ)) and the aberration field [symbol] (Φ) originating from the real world aberrations. The image intensity then is

$$\begin{matrix}\tilde{I} = \vert 𝒫 ( H ( Φ ) ) + ℛ ( Φ ) {\vert}^{2} \\ = {\vert 𝒫 ( H ( Φ ) ) \vert}^{2} + \vert ℛ ( Φ ) {\vert}^{2} + 2 \vert 𝒫 ( H ( Φ ) ) \vert \vert ℛ ( Φ ) \vert cos ( Δ θ ) ,\end{matrix} \qquad ( 13 )$$

where Δθ is the phase difference between the ideal wave field and the aberration wave field on the image plane. Note that the interference of the two wave fields can be constructive, destructive or an intermediary. However,

cos(Δθ)≤1 (14)

allows us to bound the image intensity as

\tilde{I}=| [symbol] (H(Φ)+ [symbol] (Φ))|²≤(| [symbol] (H(Φ))|+| [symbol] (Φ)|)². (15)

Assuming a given phase retrieval method for the ideal forward propagation model is accurate within ϵ-error (ϵ>0) for a local neighborhood Φ* around Φ which fulfills ∥| [symbol] (H(Φ*))|²−I∥²≤ϵ, the bound on image intensity from Eq. (15) further allows us to bound the objective in Eq. (12) as

∥| [symbol] (H(Φ*))|²−I∥²≤∥(| [symbol] (H(Φ*))|+| [symbol] (Φ*)|)²−I∥²+ϵ. (16)

With this bounded objective function in hand, we can now solve for an aberration compensating hologram phase Φ* with an ideal propagation image wave field and a wave field error, to produce an intended target image on the real prototype, that is

$${Φ}_{opt} = \begin{matrix}{minimize}_{{Φ}^{*}} & {\underbrace{{‖ {( \vert 𝒫 ( H ( {Φ}^{*} ) ) \vert + \vert ℛ ( {Φ}^{*} ) \vert )}^{2} - I ‖}^{2}}}_{upper bound error}\end{matrix} \qquad ( 17 )$$

To this end, we learn the aberration errors using a generative adversarial network (GAN), which acts as an Aberration Approximator [symbol] of the real display. We refer to this network as the Aberration Approximator in the remainder of the description herein. While the wave field itself is difficult to measure, modeling the upper bound error allows us to use the intensity instead, which can be measured by a conventional camera and is used as an input to the network. The new aberrated intensity on the image plane of a real hardware prototype is given by the updated propagated field intensity

| [symbol] (H(Φ))|²≤(| [symbol] (H(Φ))|+| [symbol] (Φ)|)²≤ [symbol] (| [symbol] (H(Φ))|²). (18)

We update the Aberration Approximator iteratively by learning the aberration wave error and optimize for a compensating hologram phase pattern. In the subsequent sections, we describe our method of constructing this approximator for the real hardware display prototype and our hologram phase optimization strategy. We note that vision aberrations including astigmatism compensation can be accurately modeled and implemented using an additional Zernike-phase. This additional phase can be directly added to our holograms to compensate for vision-induced aberrations.

### 4.3 Learned Aberration Approximator

As described in Section 3, it is challenging to formally model all deviations from the ideal forward model in a real holographic display. Furthermore, the individual steps in the physical display chain that contribute to aberrations are often non-differentiable (e.g. non-linear SLM response) which prevents using efficient first-order gradient solvers. We tackle this problem by modeling the upper bound Eq. (18) as a differentiable function [symbol] that acts as an approximation to the real hardware, and with it we can solve the upper bound Eq. (17) optimization problem. Formally, we model real-world deviations using

[symbol]

: [symbol] (19)

where [symbol] denotes the set of images computed using ideal phase hologram propagation and [symbol] is the set of real world captures.

Deep neural networks are powerful models for non-linear and non-trivial image-to-image mappings and hence are a natural choice for our differentiable hardware approximator. Existing deep learning approaches have been proposed for transferring styles (e.g. Monet to Van Gogh) [Zhu et al. 2017] or hallucinating realistic images from under-constrained semantic labels (e.g. segmentation maps, sketches) [Isola et al. 2016]. In contrast, our task is to approximate captured holographic aberrations precisely down to minute details. Departing from existing work, our aberration approximator must not hallucinate plausible, natural features involved, and the mapping to be learned needs to be constrained. As such, we propose a conditional GAN conditioned on the ideal reconstruction instead of a semantic or style guide that can be found in Pix2Pix [Isola et al. 2016]. Specifically, we train a substantially modified U-Net [Ronneberger et al. 2015] to map ideal simulated reconstructions to those captured from a real holographic display. We observe that conditioning the discriminator on the ideal simulated reconstruction provides better training stability and performance. Our training data is captured in a hardware-in-the-loop fashion as discussed in Section 5.1. We discuss the network architecture and training details in the following section.

### 4.3.1 Network Architecture

Generator. Our generator network is a modified U-Net with a base structure of 8 downsampling operations using stride 2 convolutions with 5×5 kernel window followed by symmetric upsampling using stride 2 transposed convolutions with 4×4 kernel window. However, departing from the architecture proposed in Pix2Pix [Isola et al. 2016], we cater the network towards our application through several modifications. First, we remove dropout as we found that it provides excessive regularization. Second, the last layer of the Pix2Pix U-Net consists of directly upsampling an H/2×W/2×64 feature map to the final H×W×3 RGB image, while we instead choose to first upsample to a high-resolution H×W×32 feature map before using an additional stride 1 convolution to produce the final H×W×3 RGB image. Third, we remove instance normalization from the first two encoding layers and the last two decoding layers to allow for better tone matching. Lastly, our skip connections connect the encoding layers after LeakyReLU activation instead of before as is done in Pix2Pix. For more details, please see the Supplementary Material section.

Discriminator. Using a discriminator during the training phase helps in constructing a robust loss function for improving the perceptual quality of predictions from our aberration approximator network. We use a 94×94 PatchGAN discriminator [Isola et al. 2016], which consists of three downsampling stride 2 convolutions followed by three stride 1 convolutions. The last layer uses a Sigmoid activation to convert the output of the discriminator into a probability score between 0 and 1 predicting whether the given image is a real holographic capture or a generated image. Although conditional GANs typically provide auxiliary information such as segmentation maps or edge sketches for the discriminator to be “conditioned” on, we do not utilize these in our application. Nevertheless, we found that conditioning the discriminator on the ideal simulated reconstruction improved our learned aberration approximator. In this setting, our discriminator learns to recognize realistic transformations from simulations to the actual hardware capture. Please refer to the Supplementary Material section for additional details.

Loss Function. We use a weighted combination of [symbol] ₁ loss [symbol] , perceptual loss [symbol] _{Perc} [Johnson et al. 2016], and adversarial loss [symbol] _{Adv} to train the Aberration Approximator

[symbol]

= [symbol] +λ_{Perc} [symbol] _{Perc}+λ_{Adv} [symbol] _{Adv} (20)

The perceptual loss compares the image features from activation layers in a pre-trained VGG-19 neural network, that is,

[symbol]

_{Perc}(x, y)=Σₗνₗ∥ϕₗ(x)−ϕₗ(y)∥₁, (21)

where ϕₗ is the output of the l-th layer of the VGG-19 pre-trained network and νₗ is the corresponding loss balancing weight. Specifically, we use the outputs of ReLU activations just before the first two maxpool layers, i.e. relu1_2 and2_2. The combined l₁ loss and perceptual loss act as a content loss for learning most of the aberrations in the holographic display, while the adversarial loss provides additional direction for learning any remaining errors that were missed by the content loss. In experiments, we set ν_{relu1_2}=1.5, ν_{relu2_2}=1.0, λ₁=10.0, λ_{Perc}=0.05, and λ_{Adv}=0.5 which produces a 1:1 ratio of content loss to adversarial loss.

### 4.4 Learned Hardware-in-the-Loop Hologram Optimization

In lieu of differentiable real hardware, we use a trained neural network that estimates the experimental wave errors to compensate for any aberrations, directly in the computed phase holograms. To this end, we train our Aberration Approximator network in a two-step alternating optimization approach, listed in Algorithm 1. Specifically, we alternate between optimizing for phase patterns (with fixed forward model) and optimizing for local aberration errors by refining the network with real holographic display aberrations (from fixed phase patterns). We describe both steps in the following.

Training the aberration approximator. We initialize the proposed training scheme assuming an ideal wave field at the image plane, i.e. [symbol] (Φ)=0 and optimize for the underlying phase holograms for the input dataset of target images [symbol] . When these holograms are displayed on a real prototype, severe artifacts are present which we model with the learned aberration approximator [symbol] . To this end, we acquire repeatedly captured datasets of real aberrated images [symbol] from a prototype holographic display and learn [symbol] by training a GAN as described in Section 4.3.1. With the new aberration approximator [symbol] , we then recompute the phase holograms, updating the propagation model to contain the aberrations modeled by the network, as described by Algorithm 1. Each iteration alternates between the phase computation, capture step, and aberration approximator network refinement steps using the most recent captures, thus learning to model finer residual errors than the previous iterations. Once learned, we use the frozen aberration approximator network model for all future computations of aberration compensated phase holograms.

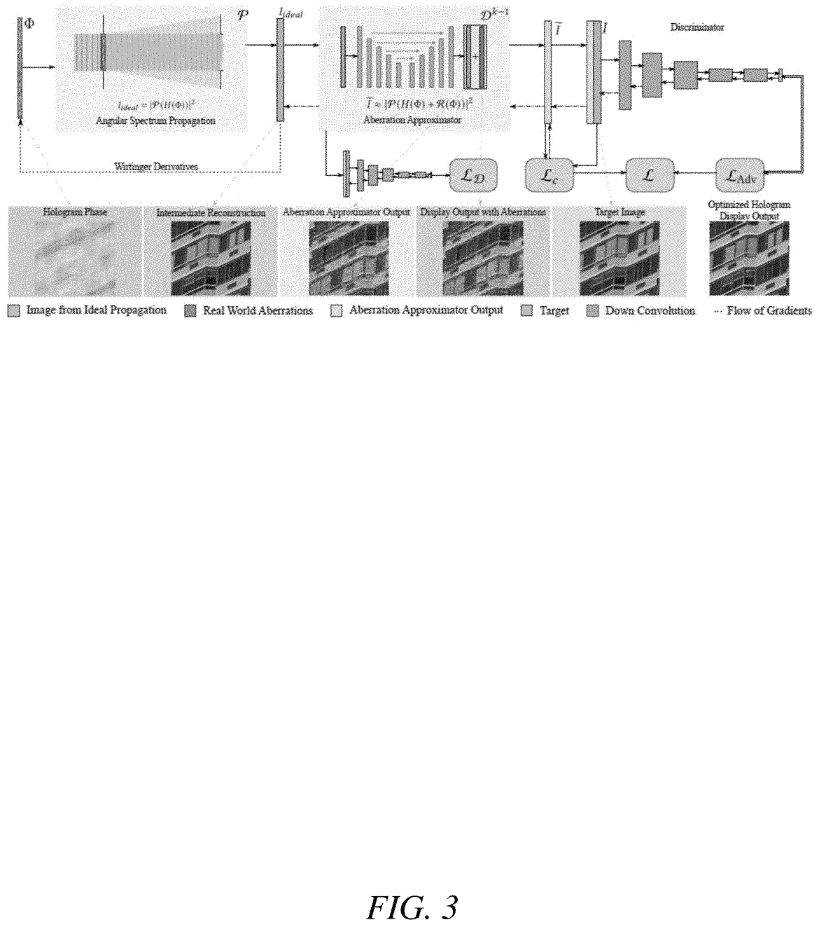

Hardware-in-the-loop phase retrieval. For the phase retrieval stage, we use the trained frozen network [symbol] to solve the aberration compensating phase optimization problem as described in Eq. (18). Our objective function is a combination of several penalty functions: 1) the learned perceptual image similarity metric (LPIPS) [Zhang et al. 2018] as a deep neural network perceptual quality metric based on human judgments, 2) multi-scale structural similarity index (MS-SSIM) [Wang et al. 2003] as a perceptual quality metric, 3) [symbol] ₂ loss for pixel-wise accuracy. We note that our aberration approximator network learns to predict the real holographic display images which typically are prone to noise, spatial and radiometric inaccuracies compared to the digital target image. While the LPIPS loss is trained to be robust to such inaccuracies, training an additional adversarial loss, as shown in FIG. 3, allows for a more robust loss function that better generalizes to real-world measured holographic images. Our overall loss function [symbol] is a weighted combination of the above mentioned content and adversarial loss functions given by

$$ℒ = {\underbrace{{ℒ}_{LPIPS} + {λ}_{ms - ssim} {ℒ}_{ms - ssim} +}}_{content loss {ℒ}_{c}} + {λ}_{Adv} {ℒ}_{Adv} \qquad ( 22 )$$

Algorithm 1
Training the aberration approximator network D.

| | |
|---|---|
| 1: | Inputs: |
| | [symbol] // Training image set |
| 2: | Outputs: |
| | [symbol] |
| 3: | // Refine aberration, approximator [symbol] for K iterations |
| 4: | [symbol] ⁰ = Id |
| 5: | for k = 1 to K do |
| 6: | // Iterate over training dataset |
| 7: | for I ∈ [symbol] do |
| 8: | // Optimize for each Φ_{I} with a fixed [symbol] |
| 9: | ${Φ}_{I}^{k - 1} ← {minimize}_{Φ} {\underbrace{ℒ ( {𝒟}^{k - 1} ( {\vert 𝒫 ( H ( Φ ) ) \vert}^{2} ) - I )}}_{upper bound error}$ |
| 10: | end for |
| 11: | // Compute ideal phase hologram images |
| 12: | [symbol] ← [symbol] (H(Φ^{k-1})) |
| 13: | // Capture real hardware aberrated images |
| 14: | [symbol] ← [symbol] (H(Φ^{k-1})) |
| 15: | // Refine [symbol] with new captures |
| 16: | [symbol] ^{k} ← refine( [symbol] ^{k-1}, [symbol] , [symbol] ) |
| 17: | end for |
| 18: | // Freeze [symbol] for future use |
| 19: | [symbol] ← [symbol] ^{K} |

Although the optimization loss function is similar to the loss function used to train our aberration approximator network, note that training of the aberration approximator is done over an entire dataset of images, whereas the phase-only hologram optimization is done for a single image, in the future, that is unseen during network training. We perform the phase retrieval by solving the above equation using the Wirtinger derivatives as described by Chakravarthula et al. [2019]. We repeat the phase optimization process until the aberration error outputs fall below a user-defined threshold. We derive the corresponding Wirtinger derivatives and offer insights into termination criteria in the Supplementary Material section.

Please note that the latest implementations of machine learning libraries, such as TensorFlow, have Wirtinger derivatives built into their auto-differentiation packages, easing the use of traditional stochastic gradient descent (SGD) methods. While Tensorflow's implementation of gradients is similar to ours, PyTorch computes the complex derivatives via a Jacobian, which implicitly computes the Wirtinger derivatives. We discuss both implementations in detail in the Supplementary Material section.

### 4.5 Extension to Online-Camera Phase Optimization

In the approach discussed above, we use a learned aberration approximator which acts as a substitute for real display and camera hardware, to compute hologram phase patterns that compensate for real hardware aberrations. This approach uses the actual display and camera hardware only for acquiring training data for the aberration approximator network (and learning the unknown light transport).

Holograms can also be actively optimized in an online fashion, using images from a camera that sees the holographic projections at each iteration as reference. In other words, holograms can be optimized to compensate for real hardware aberrations directly, without substituting the hardware with the trained aberration approximator network. Given that the light transport in a real holographic display is unknown, one can assume an ideal propagation model for the purpose of computing gradients for iterative hologram phase refinement. Alternatively, we can easily extend our network training strategy as described by Algorithm 1 to an online learning method for holographic phase retrieval of unknown propagation models. Here, the test images are now seen during training. Specifically, the alternating optimization for phase retrieval (with fixed forward model) and network refinement (with fixed holographic phase) can be used for computing aberration compensating holograms for each individual image. However, we note that such an approach takes several minutes for optimizing a single phase hologram as a result of the K sequential iterations, including display, capture, fine-tuning and training, making it impractical. We envision future training hardware to be capable of online phase refinement at fast rates. Although efficient online phase optimization is an exciting area for future research, we find that our learned hardware-in-the-loop phase retrieval method already compensates for severe real-world aberrations. We show holographic images obtained from online compensation in the Supplementary Material section.

### 5 Setup and Implementation

We assess the holograms generated by the proposed method in simulation and experimentally on a hardware display prototype. We discuss the specific hardware setup and software implementation details in the following.

### 5.1 Hardware Prototype

Our prototype holographic display uses a HOLOEYE LETO—liquid crystal on silicon (LCoS) reflective phase-only spatial light modulator with a resolution of 1920×1080 and a pixel pitch of 6.4 nm. The SLM is controlled as an external monitor and the hologram phase patterns are transferred and displayed on it via HDMI port of a graphics card. This SLM is illuminated by a collimated and linearly polarized beam from a single optical fiber that is coupled to three laser diodes. The laser diodes emit at wavelengths 446 nm, 517 nm and 636 nm and are controlled using a ThorLabs LDC205C laser diode controller in a color field sequential manner.

The illuminated beam that is modulated by the phase-only SLM is focused on an intermediate plane where an iris is placed to discard unwanted diffraction orders and conjugate images. Specifically, we use a linear phase ramp on the computed phase hologram to physically shift the holographic image away from the zero-order undiffracted light. We then block this zero-order undiffracted light and the conjugate (ghost) images using an iris, allowing primarily the modulated light to form an image. We relay this light onto the camera sensor plane. We use a Canon Rebel T6i DSLR camera body, without the camera lens attached, to capture images for the assessment of the display's image quality. The camera has an output resolution of 6000×4000 and a pixel pitch of 3.72 μm, well above the pitch of our SLM. This oversampling on the image plane allows us to effectively capture high frequency content, including noise.

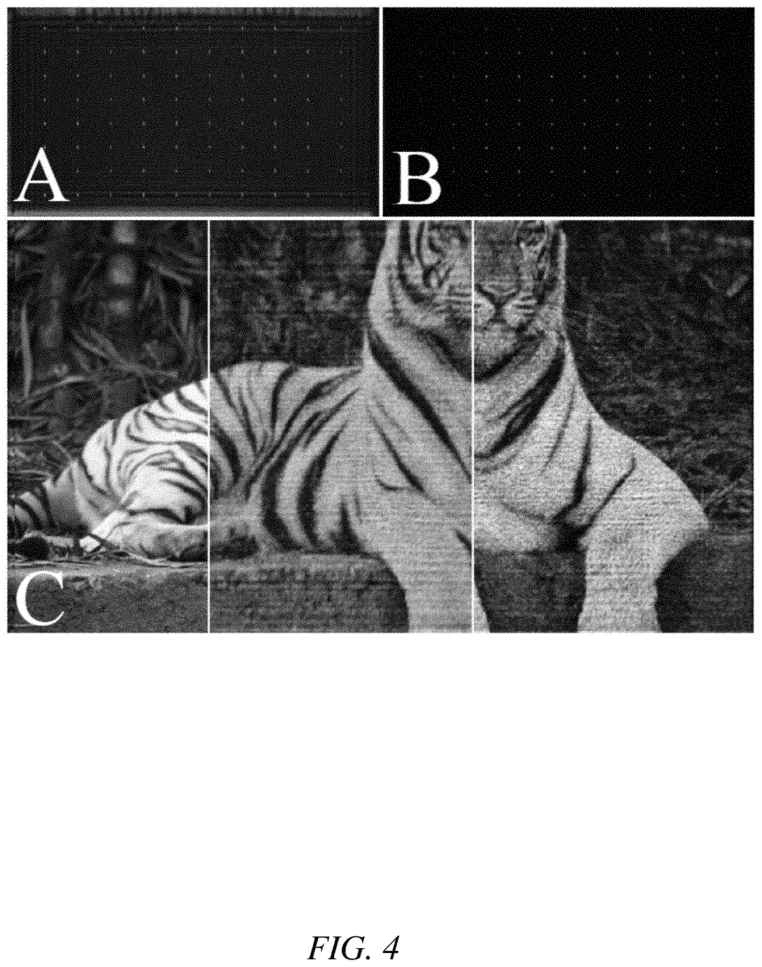

FIG. 4 validates that we have almost completely eliminated the zero-order undiffracted light. However, the additional phase ramp added to the holograms to filter out the undiffracted and conjugate light results in severe artifacts manifesting as horizontal streaks as can be seen in pane C of FIG. 4. Residual artifacts resulting from the several real-world deviations such as laser speckle, dust and scratches in the optical system, recall Section 3, further degrades the image quality noticeably. Our method successfully eliminates such severe artifacts as discussed in Section 6.

Data Acquisition. Learning the aberrations of the proposed hardware prototype requires capturing a dataset of aberrated real-world display outputs and the corresponding sharp reference images. Acquiring such data manually is often tedious and prone to errors. Specifically, misalignment between various captured images results in additional inconsistencies in the training data which are not due to the non-ideal behavior of the hardware.

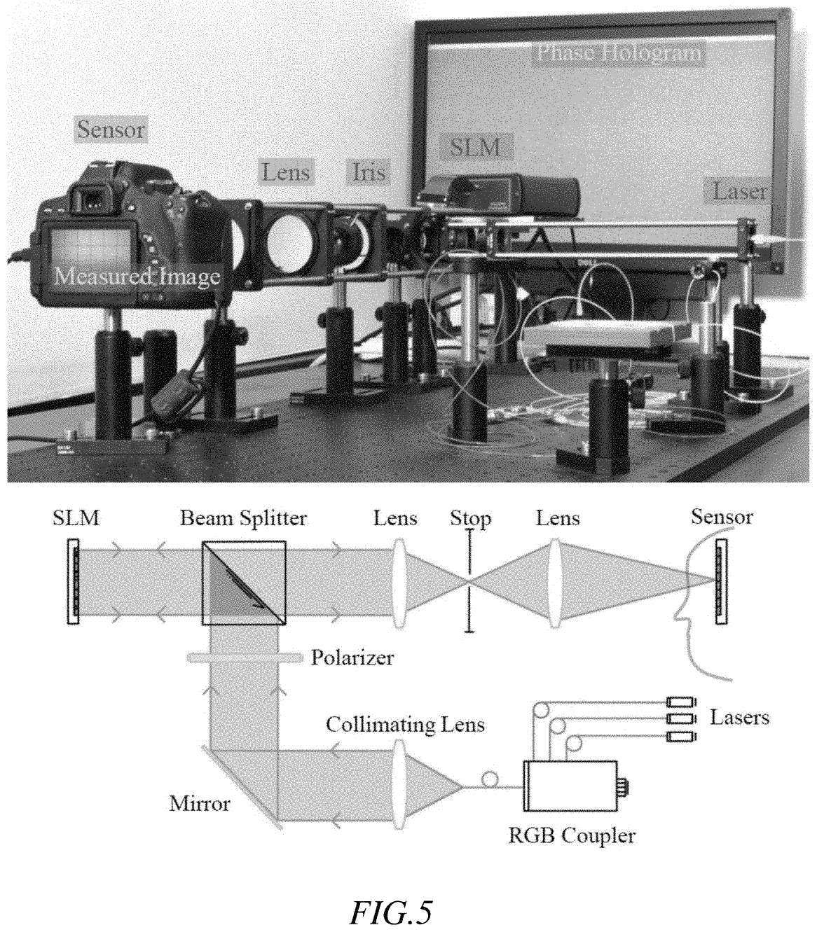

To address these challenges, we use the display-camera setup shown in FIG. 5 to acquire large training datasets robustly without human intervention This is achieved by sequentially displaying phase holograms on the SLM and simultaneously capturing the corresponding holographic projections with the camera. We repeat this process for each refinement step of our aberration approximator, as described in Section 4.4.

### 5.2 Implementation

We implement the aberration approximator and optimization procedure for the phase-only holograms using TensorFlow 1.14. We train the model on a GPU cluster providing 16 GB of memory required for handling the trained network as well as the high resolution 1080×1920 images. We do not use data augmentation techniques and instead simply train on full resolution images. For divisibility, we zero-pad the input images to 1280×2048 and then we crop the 1080×1920 region-of-interest from the output of the network. We use the Adam optimizer for both the generator and discriminator with learning rate 0.0002 and an exponential decay rate of β₁=0.5 for the first moment and β₂=0.999 for the second moment, and we train for 40000 iterations. Our batch size is one. The overall training process takes around one day for a dataset of 120 images. The source images are from our custom dataset of images randomly picked from the DIV2K dataset [Agustsson and Timofte 2017] which contains high resolution images of natural scenes.

The proposed hardware-in-the-loop optimization is implemented using TensorFlow eager execution mode to allow for Wirtinger gradient updates. We obtain the gradients of the aberration approximator and the losses from auto-differentiation using TensorFlow and use those to compute Wirtinger gradients. We optimize the phase holograms using Adam optimizer with a learning rate of 0.001 and exponential decay rates of β₁=0.9 and β₂=0.999 for the first and second moments, respectively. The optimization of the phase holograms for a given aberration approximator takes about 80 sec for 300 iterations on a consumer GPU.

### 6 Analysis

To compute holograms that compensate for experimental aberrations, the aberration approximator network has to reliably replicate the hardware artifacts. In this section, we analyze the modeling capability of the learned aberration approximator. We first compare the performance of our network architecture against existing image-to-image translation approaches. Next, we perform an ablation study to demonstrate that our architecture modifications and loss function produce meaningful improvements in modeling real aberrations. Quantitative metrics for network evaluations are calculated between the ground truth “noisy” images from the holographic display and the outputs of the approximator networks. Lastly, we demonstrate in simulation that the aberration approximator provides useful gradients for phase retrieval optimization.

### 6.1 Baseline Comparisons

We compare our proposed aberration approximator architecture and loss function against state-of-the-art image-to-image translation approaches. Specifically, we compare against the vanilla U-Net [Ronneberger et al. 2015], Pix2Pix [Isola et al. 2017], Pix2PixHD [Wang et al. 2017]. We train the U-Nets using [symbol] , [symbol] , and perceptual loss. For Pix2Pix and Pix2PixHD we use their default settings and loss functions. All methods were trained on full resolution images without augmentation. Due to memory constraints, we halve the number of filters in the U-Net at each layer and for Pix2PixHD we halve the number of filters in the first layer of the generator and discriminator. Table 1 shows PSNR, SSIM, and LPI PS evaluation results. More particularly, Table 1 illustrates an quantitative comparison against state of the art deep learning techniques for image mapping. Table 1 shows that the techniques described herein outperform existing encoder-decoder and generative adversarial approaches in predicting the aberrations on the holographic display output.

TABLE 1
Comparison of Image Mapping Techniques

| | PSNR (dB) | SSIM | 1 - LPIPS |
|---|---|---|---|
| Proposed | 29.6 | 0.831 | 0.943 |
| Proposed (unconditional) | 24.5 | 0.628 | 0.825 |
| Pix2PixHD [2017] | 24.1 | 0.565 | 0.813 |
| Pix2Pix [2016] | 24.3 | 0.614 | 0.824 |
| U-Net [2015] | 24.7 | 0.595 | 0.786 |
| U-Net [2015] with [symbol] ₂ | 24.4 | 0.563 | 0.425 |
| U-Net [2015] with [symbol] ₁ | 25.1 | 0.590 | 0.497 |

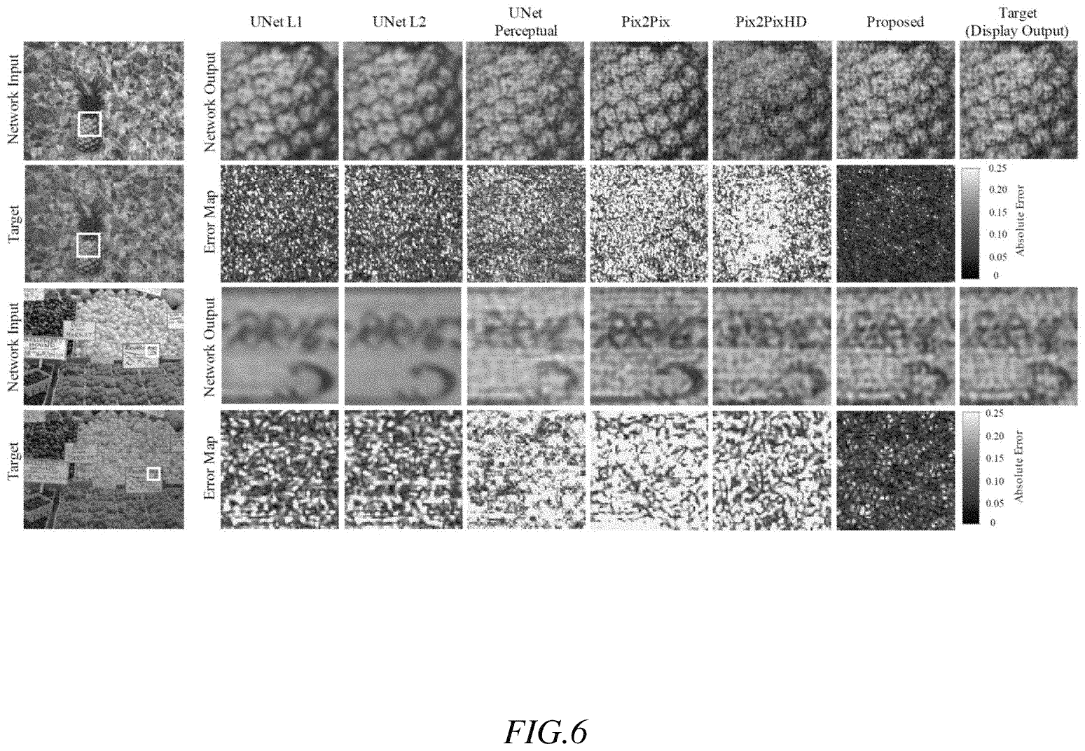

As seen in Table 1, the proposed method outperforms the state-of-the-art networks by at least 5 dB in PSNR. The SSIM results also indicate that our approach produces more perceptually accurate reconstructions than other baseline methods. FIG. 6 shows qualitative examples for a few selected images. The vanilla U-Nets with [symbol] and [symbol] losses fail to learn the diverse noise patterns. Training a U-Net with a percetual loss allows for better replication of noise but the predictions are still far from the actual aberrations and severe checkerboarding artefacts can be observed. Pix2Pix is capable of learning the aberrations to an extent, however, the color tones and patterns do not match as closely as ours. Pix2PixHD learns to generate high frequency aberrations that look plausible, but these aberrations are often misaligned with the actual display aberrations as can be seen in the error maps. Furthermore, Pix2PixHD occasionally fails and introduces additional artefacts. We found that deeper networks such as the U-Net and Pix2PixHD were more difficult to train for our task compared to shallower networks such as ours and Pix2Pix. We account this to the fact that the small loss gradients from the high frequency aberrations are difficult to backpropagate through these deeper networks.

### 6.2 Ablation Study

We performed an ablation study to demonstrate how our architecture design and loss function choices impact the aberration prediction quality. We found that training with an unconditional GAN was less stable and prone to falling into undesirable local minima, see Table 1 and the Supplementary Material section. Intuitively, conditioning the discriminator on the ideal reconstructions allowed the discriminator to focus on distinguishing the aberrations only, which provides better training signal for our generator. We refer to the Supplementary Material section for additional comparisons on the loss function components.

6.3 Simulated Phase Retrieval with Aberration Approximator

We demonstrate in simulation that using our aberration approximator provides useful gradients which allow for phase retrieval. Table 2 illustrates quantitative results for phase retrieval with the aberration approximator in simulation, starting from hardware captures obtained using Wirtinger holography with DC component removed. The quantitative improvement demonstrates that our aberration approximator provides useful gradients that allow for optimization within the Wirtinger framework.

TABLE 2
Quantitative Results for Phase Retrieval

| | PSNR (dB) | SSIM | 1 - LPIPS |
|---|---|---|---|
| Proposed | 30.4 | 0.937 | 0.949 |
| Wirtinger Holography [2019] | 19.9 | 0.571 | 0.505 |

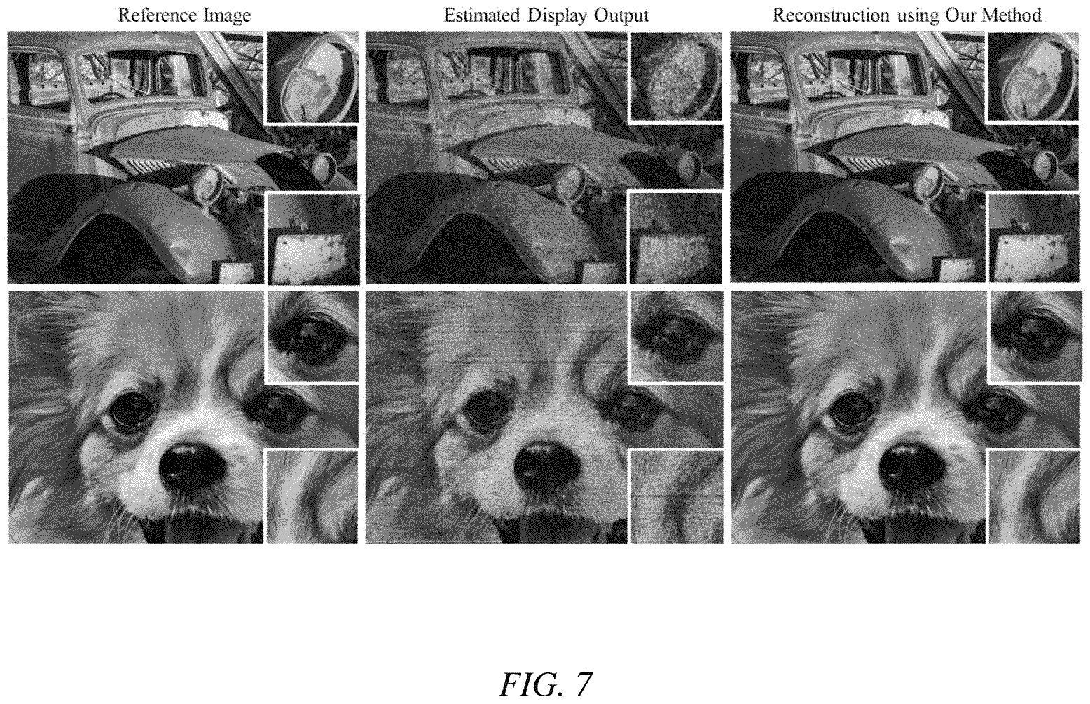

FIG. 7 shows simulated phase retrieval results with the proposed aberration approximator included as described in Section 4.4. Only instead of displaying the optimized phase pattern on the physical display, we propagate the wavefront through the ideal forward model and the aberration estimator, effectively simulating the imperfect hardware system. These synthetic results validate the effectiveness of our proposed method (Algorithm 1) Table 2 shows quantitative improvement after our optimization process in simulation. The significant improvement across all image quality metrics demonstrates that the proposed technique indeed compensates for the adequately modeled hardware deviations. We note, since our aberration approximator is trained to map ideal Wirtinger reconstructions to hardware captures, it is unsuitable for evaluating other methods such as double phase encoding [Maimone et al. 2017], in the same simulation framework. As such, we defer to the next section for comparisons on the hardware prototype.

### 7. Assessment

Table 3 shows Quantitative results for holographic reconstructions using different phase retrieval methods. Metrics are computed on hardware captures compared against the aligned target image. For fair comparison we adjust intensities to match the target image intensity. The proposed method not only outperforms other methods by 2.5 dB PSNR, but also greatly improves the SSIM and LPIPS perceptual metrics, and thus quantitatively demonstrates improved perceptual quality.

TABLE 3
Quantitative Results for Holographic Reconstructions

| Real display output | PSNR (dB) | SSIM | 1-LPIPS |
|---|---|---|---|
| Proposed | 20.5 | 0.625 | 0.541 |
| Wirtinger Holography [2019] | 17.6 | 0.475 | 0.417 |
| Double Phase Encoding [2017] | 15.24 | 0.342 | 0.208 |

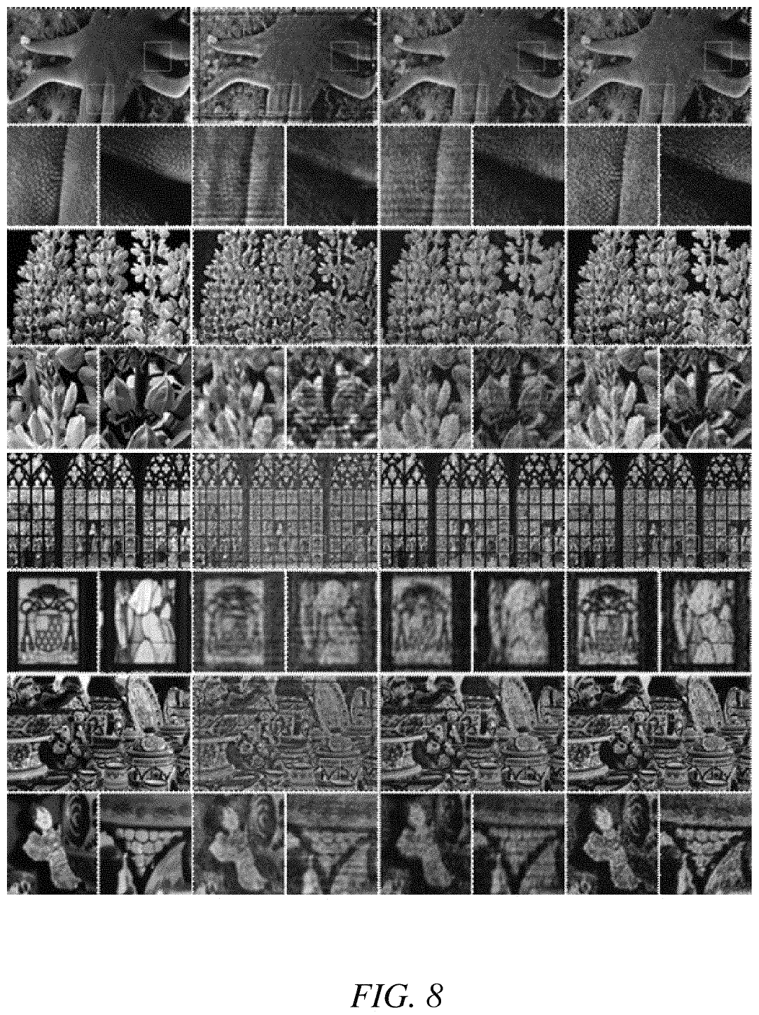

We validate and evaluate our approach for real-world use by comparing it to the state-of-the-art holographic phase retrieval methods, Double phase encoding [Maimone et al. 2017] and Wirtinger Holography [Chakravarthula et al. 2019], in full color. FIG. 8 shows experimentally acquired results from the holographic display setup described in Section 5.1. The proposed method outperforms existing state-of-the-art methods quantitatively and qualitatively for real-world display captures.

For the purpose of acquiring these results, we covered our hardware prototype with blackout curtains to mitigate the effect of ambient light on the final captures. We maintained the SLM look-up-tables (LUTs), camera settings and laser settings constant throughout the various experiments. In particular, we computed holograms of a resolution test pattern showing TV lines of varying frequencies and finetuned the camera sensor plane position until all the frequencies in the TV chart can be seen, to minimize any loss of frequencies due to camera defocus errors. We kept the camera ISO at 100 and exposure at 10 ms. We used the SLM look up tables (LUTs) provided by the manufacturer to display the calibration TV-hologram but tuned the voltages by a small amount until a maximum diffraction efficiency is noticed. The LUTs and the corresponding voltages are then kept constant for all the experiments.

We found that the holograms for other methods needed an extra gamma correction to the phase patterns, before displaying on the hardware, for improved performance on our aged SLM with inaccurate look-up-tables, aiming for best hand-tuned display outputs. In contrast, we do not apply such gamma correction to the phase patterns from our hardware-in-the-loop method and the proposed approach directly compensates for the phase errors. Also, since the double phase encoding leads to the unwanted effect of a noticeable portion of light escaping the designated image window, we increase the laser power for these holograms to match the intensities for a fair comparison. We note that our optical setup is optimized to relay a real projected image directly to the sensor of the DSLR camera (Section 5.1) without lens distortions, eliminating the need for additional calibration.

The real captured results reported in FIG. 8 show that the proposed approach compensates for most of the severe aberrations occurring in existing methods. We eliminate the zero-order undiffracted light that is caused by the dead pixel space in the SLM as discussed in Section 5.1. This significantly improves the contrast and can be seen in the results reported, e.g. the black regions between the flowers in second row and the doll in the last row of results. The proposed approach eliminates the ringing at the edges of the holographic projections and reconstruction noise that is present in existing methods. This can be observed in the image patches that are selected from the peripheries of the real captures. As a result, fine details such as the skin of the star fish in the first row and texture on the porcelain in the last row are revealed by the proposed method in contrast to Wirtinger holography or double phase encoding methods. Similarly, the fine details on the flowers and the colored glass window in the middle rows is made visible with the proposed method at high contrast and resolution.

We further validate our method by computing several image quality metrics such as PSNR, SSIM and LPIPS perceptual similarity on real holographic images from a custom test dataset consisting of images randomly chosen from the DIV2K dataset [Agustsson and Timofte 2017] and that are not seen by the aberration approximator before during the training stage. The resulting quality metrics for the real captured holographic images for our method compared against the state-of-the-art double phase encoding and Wirtinger holography are reported in Table 3. The target display images were first gamma-corrected and the holograms of these gamma-corrected intensity images were computed. These holograms were displayed on a real holographic display and captured with a linear camera sensor to compute the corresponding image quality metrics between the captured images and the gamma-corrected targets. The proposed method demonstrates 2.5 dB improvement over the prior methods and significant increases in SSIM and LPIPS performance—validating the improved quality of the real holographic images shown in FIG. 8. For further evaluation, we provide additional real captured results in Supplementary Material section.

### 7.1 3D Holographic Display

We also extend the proposed hardware-in-the-loop phase retrieval method to tackle 3D volumetric scenes via dynamic global scene focus. Computing full Fresnel holograms of 3D scenes using point-source integration methods generally result in holographic imagery with continuous per-pixel focus cues. However, these methods require computing and superposing the underlying lens phase patterns individually for several million points that make the 3D scene, which is a computationally expensive process. Moreover, such Fresnel holograms are typically not phase-only and require either a complex modulation of both amplitude and phase [Shih et al. 2017], or a heuristic encoding of the complex hologram [Maimone et al. 2017]. Each of these approaches results in reduction of the holographic projection quality. As an alternative, the 3D volume can be discretized into multiple focal planes and a superposition of holograms corresponding to only those depth planes can be computed to render a 3D hologram. The holograms for each focal plane can be independently or jointly computed using our optimization framework, however, at the cost of a reduction in speed by N for N discrete depth planes.

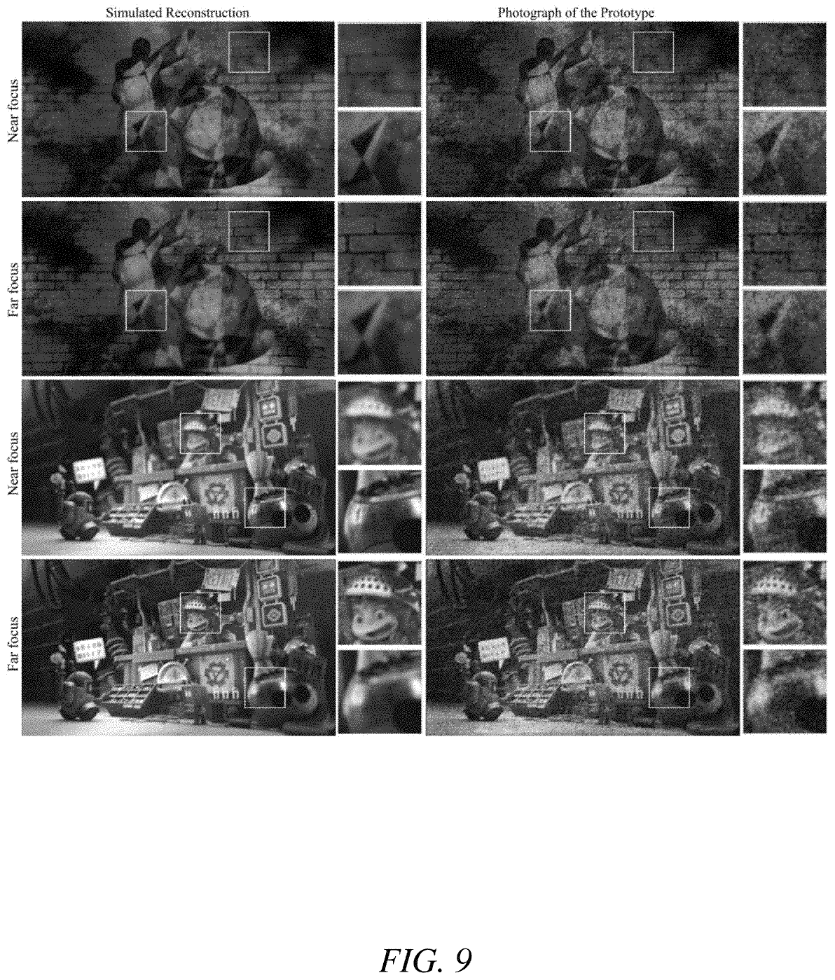

Therefore, we provide 3D holograms by sweeping holographic projections of 2D scenes through the 3D volume in space, via dynamic global scene focus. Specifically, since the human eye can focus only at a single depth at any given instant of time, we display a 2D hologram of the 3D scene whose focus is changed to match the focal depth of the user's eye [Maimone et al. 2017]. The depth of field blur in the scenes is rendered in image space [Chakravarthula et al. 2018; Cholewiak et al. 2017]. While correcting for the aberrations at various depths as described by Maimone et al. [2017] is an option, that requires training the aberration approximator with holographic images generated and captured at various discretely sampled depths. Instead, we train our aberration approximator to predict deviations at a single depth but add additional lens phase functions to the aberration compensated holograms to move the projections across the continuous 3D volume. As shown in FIG. 9, the global focus change of the 3D scenes is accurately displayed on our holographic display prototype.

### 7.2 Robustness to Eye Motion and Display Variability

In this section, we evaluate the robustness of our method to spatial, temporal and systemic changes in the display-capture setup, and its inherent hardware limitations.

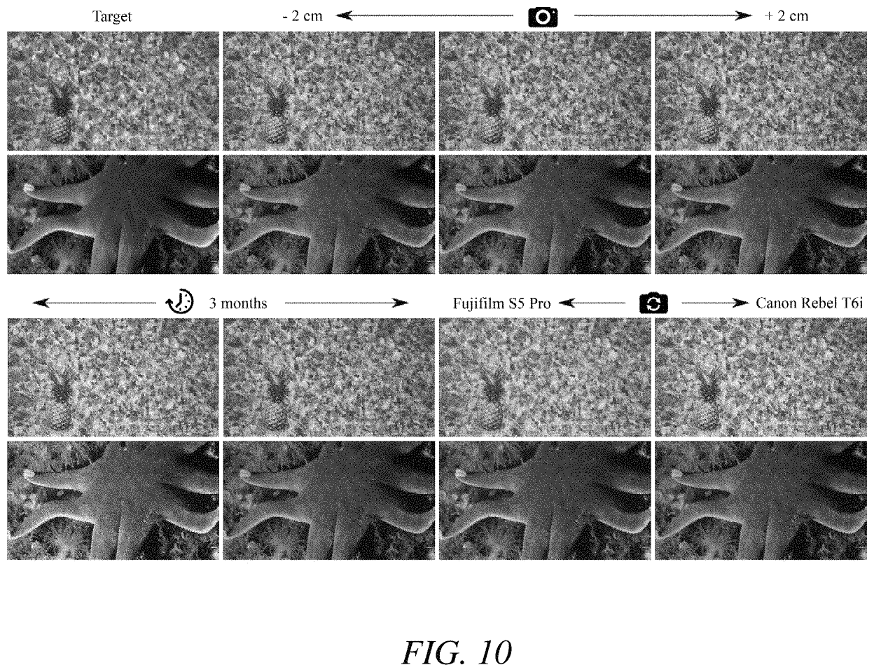

Robustness to Eye Motion. To evaluate the quality of aberration-compensated holographic images with eye motion, we compare the quality of display outputs captured for various unseen horizontal and vertical translations of a Canon T6i DSLR camera. Note that the holograms for this experiment are generated using an aberration approximator network that is trained on a dataset of holographic images captured with a fixed camera position. A subset of images shown in the top row of FIG. 10 shows that the overall quality of holographic images remain stable with the camera motion up to 4 cm.

Robustness to Temporal Variability. To assess the performance of the trained network to temporal variations of the hardware, we compare the captured images from the hardware display prototype over a time window of three months with a Canon T6i DSLR camera, as shown in the bottom left of FIG. 10. It can be noticed that our aberration approximator predicts real world deviations consistently and there is no significant change in the image quality of aberration-compensated holographic projections over time. The disparities in the brightness and color is due to the differences in the laser power and we note that these are not fundamental to the proposed method.

Robustness to Acquisition Device. While the dataset of real hardware captures that we use for training the aberration approximator network inherently contains the nonlinearities of the camera, we tailor our holographic phase optimization loss functions to be perceptually consistent but agnostic to radiometric variations as discussed in Section 4.4. Also note that the optical layout used in our setup is designed to relay the holographic image directly on the camera sensor without any lens distortion or chromatic aberration, eliminating the need for additional lens calibration. To validate this, we capture and compare the display output with two different cameras: a Canon Rebel T6i DSLR camera of resolution 6000×4000 and a Fujifilm FinePix S5 Pro DSLR camera of resolution 4256×2848. The Canon T6i has a 24 MP APS-C (22.3×14. 0 mm) sized CMOS sensor and features DIGIC 6 processor. On the other hand, Fujifilm S5 Pro has a 6 MP APS-C (23×15.5 mm) sized CCD sensor. Despite the two devices having entirely different imaging sensor properties, the display captures from either cameras are consistent, as shown in lower right part of the FIG. 10, and validate the robustness of our optimization framework against radiometric variability of acquisition devices.

### 8. Discussion and Conclusion

We introduce a machine learned hardware-in-the-loop phase retrieval method to estimate the unknown forward model in a real holographic display. The proposed method allows us to compensate hardware deviations from the ideal forward model which are non-linear and difficult to model. To this end, we learn an aberration approximator from hardware captures, that is parameterized by a deep neural network, and effectively emulates the real hardware. Using this aberration approximator function allows us to formulate the holographic phase retrieval problem as an optimization problem that can be solved using first-order optimization methods. The proposed approach iteratively refines the upper bound on the estimated objective function which we have derived in this work.

We validate that our aberration approximator accurately models images acquired from our prototype display. We assess the proposed phase retrieval approach by solving for phase-only holograms that compensate for severe errors. In particular, our approach eliminates severe non-linear artifacts in the real holographic reconstructions. Without modeling deviations, the approach allows us to eliminate zero-order undiffracted light, non-ideal and non-linear phase response of the SLM device and severe ringing and chromatic artifacts that are not tackled by existing phase retrieval methods.

The proposed method outperforms existing state-of-the-art methods quantitatively and qualitative for real-world display captures. We envision the proposed hardware-in-the-loop phase retrieval method to enable research towards high-quality artifact-free holographic near-eye displays of the future.

### Exemplary System and Method

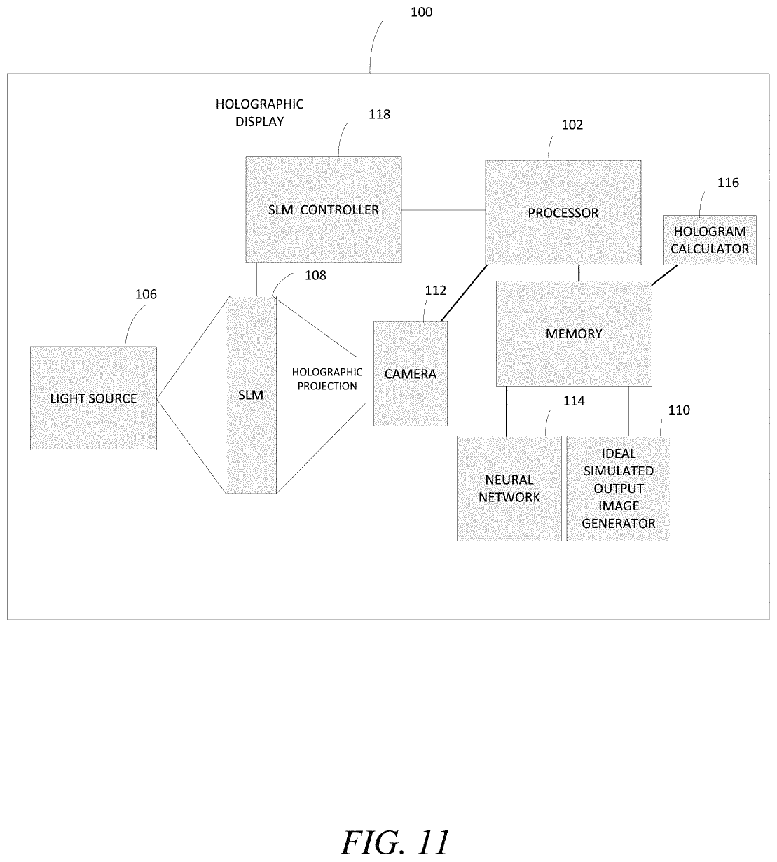

FIG. 11 is a block diagram illustrating an exemplary system for hardware-in-the-loop phase retrieval for near eye displays. Referring to FIG. 11, the system includes a holographic display 100 that includes at least one processor 102, a memory 104, a light source 106, and a configurable spatial light modulator 108. The system further includes an ideal output image generator 110 for generating simulated ideal output images of the holographic display. In one example, the simulated ideal output images can be generated using Wirtinger holography assuming ideal display optics, as described above. The system further includes a camera 112 for capturing real output images of the holographic display. The system further includes a neural network 114 for learning a mapping between the simulated ideal output images and the real output images. In one example, the neural network comprises a GAN and the associated discriminators, as illustrated in FIG. 4. The system further includes a hologram calculator 116 for using the aberration model learned by the neural network to solve for an aberration compensating hologram phase. The system further includes an SLM controller 118 for using the aberration compensating hologram phase to adjust the phase pattern of spatial light modulator 108.

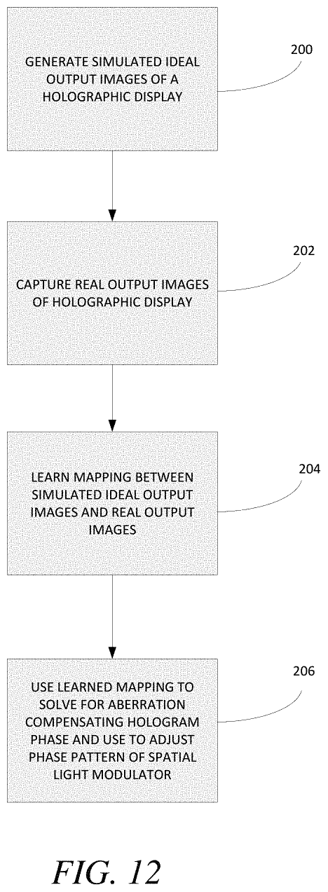

FIG. 12 illustrates an exemplary process for learned hardware-in-the-loop phase retrieval for holographic near-eye displays. Referring to FIG. 12, in step 200, the process includes generating simulated ideal output images of a holographic display. Step 200 may include computing the output images assuming ideal light propagation through the display optics. In step 202, the process includes capturing real output images of the holographic display. The real output images may be captured using camera 112. In step 204, the process further includes learning a mapping between the simulated ideal output images and the real output images. For example, as described above, a neural network can be trained to learn a model of the aberrations generated by non-ideal propagation of light through the display optics. In step 206, the process further includes using the learned mapping to solver for an aberration compensating hologram phase and using the aberration compensating hologram phase to adjust a phase pattern of the spatial light modulator. For example, the learned aberrations model can be used to solve Equation 18 for the aberration compensating hologram phase, which may be used to adjust the phases of the pixels in the spatial light modulator to compensate for the aberrations in the displayed image generated by the display optics.

The disclosure of each of the following references is hereby incorporated herein by reference in its entirety.

### REFERENCES

Eirikur Agustsson and Radu Timofte. 2017. NTIRE 2017 Challenge on Single Image Super-Resolution: Dataset and Study. In IEEE International Conference on Computer Vision and Pattern Recognition (CVPR) Workshops.

Lukas Ahrenberg, Philip Benzie, Marcus Magnor, and John Watson. 2008. Computer generated holograms from three dimensional meshes using an analytic light transport model. Applied optics 47,10 (2008), 1567-1574.

Sohail Bahmani and Justin Romberg. 2017. Phase Retrieval Meets Statistical Learning Theory: A Flexible Convex Relaxation. In Proceedings of the 20th International Conference on Artificial Intelligence and Statistics (Proceedings of Machine Learning Research), Vol. 54. PMLR, 252-260.

George Barbastathis, Aydogan Ozcan, and Guohai Situ. 2019. On the use of deep learning for computational imaging. Optica 6,8 (2019), 921-943.

Heinz H Bauschke, Patrick L Combettes, and D Russell Luke. 2003. Hybrid projection—reflection method for phase retrieval. JOSA A 20,6 (2003), 1025-1034.

Muharrem Bayraktar and Meriç Özcan. 2010. Method to calculate the far field of three-dimensional objects for computer-generated holography. Applied optics 49,24 (2010), 4647-4654.

Vittorio Bianco, Pasquale Memmolo, Marco Leo, Silvio Montresor, Cosimo Distante, Melania Paturzo, Pascal Picart, Bahram Javidi, and Pietro Ferraro. 2018. Strategies for reducing speckle noise in digital holography. Light: Science & Applications 7, 1 (2018), 1-16.

Vittorio Bianco, Pasquale Memmolo, Melania Paturzo, Andrea Finizio, Bahram Javidi, and Pietro Ferraro. 2016. Quasi noise-free digital holography. Light: Science & Applications 5,9 (2016), e16142.

Emmanuel J Candes, Thomas Strohmer, and Vladislav Voroninski. 2013. Phaselift: Exact and stable signal recovery from magnitude measurements via convex programming. Communications on Pure and Applied Mathematics 66, 8 (2013), 1241-1274.

Praneeth Chakravarthula, David Dunn, Kaan Akşit, and Henry Fuchs. 2018. Focusar: Auto-focus augmented reality eyeglasses for both real world and virtual imagery. IEEE transactions on visualization and computer graphics 24, 11 (2018), 2906-2916.

Praneeth Chakravarthula, Yifan Peng, Joel Kollin, Henry Fuchs, and Felix Heide. 2019. Wirtinger holography for near-eye displays. ACM Transactions on Graphics (TOG) 38, 6 (2019), 213.

Praneeth Chakravarthula, Yifan Peng, Joel Kollin, Felix Heide, and Henry Fuchs. 2020.

Computing high quality phase-only holograms for holographic displays. In Optical Architectures for Displays and Sensing in Augmented, Virtual, and Mixed Reality (AR, VR, MR), Vol. 11310. International Society for Optics and Photonics, 1131006.

J S Chen and D P Chu. 2015. Improved layer-based method for rapid hologram generation and real-time interactive holographic display applications. Optics express 23, 14 (2015), 18143-18155.

Rick H-Y Chen and Timothy D Wilkinson. 2009. Computer generated hologram from point cloud using graphics processor. Applied optics 48, 36 (2009), 6841-6850.

Steven A Cholewiak, Gordon D Love, Pratul P Srinivasan, Ren Ng, and Martin S Banks. 2017. ChromaBlur: Rendering chromatic eye aberration improves accommodation and realism. ACM Transactions on Graphics (TOG) 36, 6 (2017), 210.

J Christopher Dainty. 1977. I The statistics of speckle patterns. In Progress in optics. Vol. 14. Elsevier, 1-46.

W J Dallas and A W Lohmann. 1972. Phase quantization in holograms—depth effects. Applied optics 11, 1 (1972), 192-194.

James R Fienup. 1982. Phase retrieval algorithms: a comparison. Applied optics 21, 15 (1982), 2758-2769.

James R Fienup. 1993. Phase-retrieval algorithms for a complicated optical system. Applied optics 32, 10 (1993), 1737-1746.

Ralph W Gerchberg. 1972. A practical algorithm for the determination of the phase from image and diffraction plane pictures. Optik 35 (1972), 237-246.

Lior Golan and Shy Shoham. 2009. Speckle elimination using shift-averaging in highrate holographic projection. Optics express 17, 3 (2009), 1330-1339.

Tom Goldstein and Christoph Studer. 2018. PhaseMax: Convex phase retrieval via basis pursuit. IEEE Transactions on Information Theory (2018).

R A Gonsalves. 1976. Phase retrieval from modulus data. JOSA 66, 9 (1976), 961-964.

Joseph W Goodman. 2005. Introduction to Fourier optics. Roberts and Company Publishers.

Phillip Isola, Jun-Yan Zhu, Tinghui Zhou, and Alexei A Efros. 2016. Image-to-Image

Translation with Conditional Adversarial Networks. IEEE International Conference on Computer Vision and Pattern Recognition (CVPR) (2016), 5967-5976.

Phillip Isola, Jun-Yan Zhu, Tinghui Zhou, and Alexei A Efros. 2017. Image-to-Image

Translation with Conditional Adversarial Networks. In IEEE International Conference on Computer Vision and Pattern Recognition (CVPR).

Changwon Jang, Kiseung Bang, Gang Li, and Byoungho Lee. 2019. Holographic neareye display with expanded eye-box. ACM Transactions on Graphics (TOG) 37, 6 (2019), 195.

Changwon Jang, Kiseung Bang, Seokil Moon, Jonghyun Kim, Seungjae Lee, and Byoungho Lee. 2017. Retinal 3D: augmented reality near-eye display via pupil-tracked light field projection on retina. ACM Transactions on Graphics (TOG) 36, 6 (2017), 190.

Jia, Juan Liu, Guofan Jin, and Yongtian Wang. 2014. Fast and effective occlusion culling for 3D holographic displays by inverse orthographic projection with low angular sampling. Applied optics 53, 27 (2014), 6287-6293.

Justin Johnson, Alexandre Alahi, and Li Fei-Fei. 2016. Perceptual Losses for Real-Time

Style Transfer and Super-Resolution. In European Conference on Computer Vision (ECCV).

Xin Kang. 2008. An effective method for reducing speckle noise in digital holography. Chinese Optics Letters 6, 2 (2008), 100-103.

Hwi Kim, Joonku Hahn, and Byoungho Lee. 2008. Mathematical modeling of trianglemesh-modeled three-dimensional surface objects for digital holography. Applied optics 47, 19 (2008), D117-D127.

R G Lane. 1991. Phase retrieval using conjugate gradient minimization. Journal of Modern Optics 38, 9 (1991), 1797-1813.

Douglas Lanman and David Luebke. 2013. Near-eye light field displays. ACM Transactions on Graphics (TOG) 32, 6 (2013), 220.

Detlef Leseberg and Christian Frère. 1988. Computer-generated holograms of 3-D objects composed of tilted planar segments. Applied optics 27, 14 (1988), 3020-3024.

L B Lesem, P M Hirsch, and J A Jordan. 1969. The kinoform: a new wavefront reconstruction device. IBM Journal of Research and Development 13, 2 (1969), 150-155.

Anat Levin, Haggai Maron, and Michal Yarom. 2016. Passive light and viewpoint sensitive display of 3D content. In 2016 IEEE International Conference on Computational Photography (ICCP). IEEE, 1-15.

Gang Li, Dukho Lee, Youngmo Jeong, Jaebum Cho, and Byoungho Lee. 2016. Holographic display for see-through augmented reality using mirror-lens holographic optical element. Optics letters 41, 11 (2016), 2486-2489.

Mark Lucente and Tinsley A Galyean. 1995. Rendering interactive holographic images. In Proceedings of the 22nd annual conference on Computer graphics and interactive techniques. ACM, 387-394.

Mark E Lucente. 1993. Interactive computation of holograms using a look-up table. Journal of Electronic Imaging 2, 1 (1993), 28-34.

Andrew Maimone, Andreas Georgiou, and Joel S Kollin. 2017. Holographic near-eye displays for virtual and augmented reality. ACM Transactions on Graphics (TOG) 36, 4 (2017), 85.

Stefano Marchesini, Yu-Chao Tu, and Hau-tieng Wu. 2016. Alternating projection, ptychographic imaging and phase synchronization. Applied and Computational Harmonic Analysis 41, 3 (2016), 815-851.

Nobuyuki Masuda, Tomoyoshi Ito, Takashi Tanaka, Atsushi Shiraki, and Takashige Sugie. 2006. Computer generated holography using a graphics processing unit. Optics Express 14, 2 (2006), 603-608.

Kyoji Matsushima. 2005. Computer-generated holograms for three-dimensional surface objects with shade and texture. Applied optics 44, 22 (2005), 4607-4614.

Kyoji Matsushima and Sumio Nakahara. 2009. Extremely high-definition full-parallax computer-generated hologram created by the polygon-based method. Applied optics 48, 34 (2009), H54-H63.

Kyoji Matsushima, Masaki Nakamura, and Sumio Nakahara. 2014. Silhouette method for hidden surface removal in computer holography and its acceleration using the switch-back technique. Optics express 22, 20 (2014), 24450-24465.

Nitish Padmanaban, Yifan Peng, and Gordon Wetzstein. 2019. Holographic near-eye displays based on overlap-add stereograms. ACM Transactions on Graphics (TOG) 38, 6 (2019), 214.

Yifan Peng, Xiong Dun, Qilin Sun, and Wolfgang Heidrich. 2017. Mix-and-match holography. ACM Transactions on Graphics (2017).

Christoph Petz and Marcus Magnor. 2003. Fast hologram synthesis for 3D geometry models using graphics hardware. In Proc. SPIE, Vol. 5005. 266-275.

Stephan Reichelt, Ralf Häussler, Gerald Futterer, Norbert Leister, Hiromi Kato, Naru Usukura, and Yuuichi Kanbayashi. 2012. Full-range, complex spatial light modulator for real-time holography. Optics letters 37, 11 (2012), 1955-1957.

Olaf Ronneberger, Philipp Fischer, and Thomas Brox. 2015. U-net: Convolutional networks for biomedical image segmentation. In International Conference on Medical image computing and computer-assisted intervention. Springer, 234-241.

Liang Shi, Fu-Chung Huang, Ward Lopes, Wojciech Matusik, and David Luebke. 2017. Near-eye light field holographic rendering with spherical waves for wide field of view interactive 3d computer graphics. ACM Transactions on Graphics (TOG) 36, 6 (2017), 236.

Quinn Y J Smithwick, James Barabas, Daniel E Smalley, and V Michael Bove. 2010. Interactive holographic stereograms with accommodation cues. In Practical Holography XXIV: Materials and Applications, Vol. 7619. International Society for Optics and Photonics, 761903.

Tullio Tommasi and Bruno Bianco. 1993. Computer-generated holograms of tilted planes by a spatial frequency approach. JOSA A 10, 2 (1993), 299-305.

Ting-Chun Wang, Ming-Yu Liu, Jun-Yan Zhu, Andrew Tao, Jan Kautz, and Bryan Catanzaro. 2017. High-Resolution Image Synthesis and Semantic Manipulation with Conditional GANs. IEEE International Conference on Computer Vision and Pattern Recognition (CVPR) (2017), 8798-8807.

Zhou Wang, Eero P Simoncelli, and Alan C Bovik. 2003. Multiscale structural similarity for image quality assessment. In The Thirty-Seventh Asilomar Conference on Signals, Systems & Computers, 2003, Vol. 2. IEEE, 1398-1402.

James P Waters. 1966. Holographic image synthesis utilizing theoretical methods. Applied physics letters 9, 11 (1966), 405-407.

Zaiwen Wen, Chao Yang, Xin Liu, and Stefano Marchesini. 2012. Alternating direction methods for classical and ptychographic phase retrieval. Inverse Problems 28, 11 (2012), 115010.

Gordon Wetzstein, Douglas Lanman, Matthew Hirsch, and Ramesh Raskar. 2012. Tensor displays: compressive light field synthesis using multilayer displays with directional backlighting. (2012).

Masahiro Yamaguchi, Hideshi Hoshino, Toshio Honda, and Nagaaki Ohyama. 1993. Phase-added stereogram: calculation of hologram using computer graphics technique. In Proc. SPIE, Vol. 1914. 25-31.

Han-Ju Yeom, Hee-Jae Kim, Seong-Bok Kim, HuiJun Zhang, BoNi Li, Yeong-Min Ji, Sang-Hoo Kim, and Jae-Hyeung Park. 2015. 3D holographic head mounted display using holographic optical elements with astigmatism aberration compensation. Optics express 23, 25 (2015), 32025-32034.

Hiroshi Yoshikawa, Takeshi Yamaguchi, and Hiroki Uetake. 2016. Image quality evaluation and control of computer-generated holograms. In Practical Holography XXX: Materials and Applications, Vol. 9771. International Society for Optics and Photonics, 97710N.

Hao Zhang, Yan Zhao, Liangcai Cao, and Guofan Jin. 2015. Fully computed holographic stereogram based algorithm for computer-generated holograms with accurate depth cues. Optics express 23, 4 (2015), 3901-3913.

Hao Zhang, Yan Zhao, Liangcai Cao, and Guofan Jin. 2016. Layered holographic stereogram based on inverse Fresnel diffraction. Applied optics 55, 3 (2016), A154-A159.

Jingzhao Zhang, Nicolas Pegard, Jingshan Zhong, Hillel Adesnik, and Laura Waller.

2017. 3D computer-generated holography by non-convex optimization. Optica 4, 10 (2017), 1306-1313.

Richard Zhang, Phillip Isola, Alexei A. Efros, Eli Shechtman, and Oliver Wang. 2018.

The unreasonable effectiveness of deep features as a perceptual metric. In IEEE International Conference on Computer Vision and Pattern Recognition (CVPR).

Yan Zhao, Liangcai Cao, Hao Zhang, Dezhao Kong, and Guofan Jin. 2015. Accurate calculation of computer-generated holograms using angular-spectrum layer-oriented method. Optics express 23, 20 (2015), 25440-25449.

Jun-Yan Zhu, Taesung Park, Phillip Isola, and Alexei A Efros. 2017. Unpaired Image-to-Image Translation Using Cycle-Consistent Adversarial Networks. IEEE International Conference on Computer Vision (ICCV) (2017), 2242-2251.

### Supplementary Material

### Forward Model Approximations

Several wave propagation models can be derived from the diffraction integral as discussed above. In this section, we discuss various formulations of the diffraction integral that are relevant for near-eye display holography.

### Angular Spectrum Propagation

As described above, the diffraction integral for calculating the wave propagation can be expressed as

E_{I}(x, y)=∫_{-∞}^{∞}∫_{-∞}^{∞}H(ζ, η)E_{R}(ζ, η)·g(x−ƒ, y−η)dζdη, (1)

where the kernel

$$g ( ζ , η ) = \frac{1}{j λ} \frac{exp [ jk \sqrt{{d}^{2} + {ζ}^{2} + {η}^{2}} ]}{\sqrt{{d}^{2} + {ζ}^{2} + {η}^{2}}} . \qquad ( 2 )$$

is the impulse response of free space propagation. Invoking the convolution theorem lets us express Eq. 1 as

E_{I}=(H·E_{R})*g= [symbol] ⁻¹( [symbol] [H·E_{R}]· [symbol] [g]). (3)

where · is the Hadamard element-wise product and [symbol] is the Fourier transform operator. Assuming a plane wave illumination, computing the Fourier transform of the kernel g in the above equation results in

E_{I}= [symbol] ⁻¹( [symbol] [H]·G). (4)

where G is the ASM transfer function given by

$$G ( {f}_{x} , {f}_{y} ; z ) = \{ \begin{matrix}exp [ j 2 π \frac{z}{λ} \sqrt{1 - {( λ {f}_{x} )}^{2} - {( λ {f}_{y} )}^{2}} ] & , & \sqrt{{f}_{x}^{2} + {f}_{y}^{2}} < \frac{1}{λ} \\ 0 & , & otherwise\end{matrix} . \qquad ( 5 )$$

This propagation model is called the angular spectrum propagation of the wave field. Following the above equation, the diffractive wave field from the SLM, if Fourier-analyzed across any plane, can be identified as plane waves traveling in different directions away from the hologram plane. Therefore, the field amplitude across any point can be calculated as the summation of contributions of these plane waves, taking into account the phase shifts undergone during the propagation. The angular spectrum method (ASM) assumes no approximations. It is equivalent to the Rayleigh-Sommerfeld solution and yields identical predictions of the diffracted wave field [Shen and Wang 2006].

### Fresnel and Fraunhofer Approximations

Following the diffraction integral as described in Eq. 1 in Section 3, notice that the integral computes the Euclidean distance between the points on the hologram plane and the image plane where the wave is propagated. The Euclidean distance ρ=\sqrt{(ζ−x)²+(η−y)²+d²} can be expressed as

$$ρ = d \sqrt{1 + {[ \frac{( ζ - x )}{d} ]}^{2} + {[ \frac{( η - y )}{d} ]}^{2}} . \qquad ( 6 )$$

Next, by binomial expansion, the above equation can be expressed as

ρ=d[1+ [symbol] /2− [symbol] /8+ . . . ], (7)

where [symbol] =[(ζ−x)²+(η−y)²]/d².
Now, if the distance between the hologram and image plane d is sufficiently large compared to (ζ−x) and (η−y), then the p in the exponential can be approximated by

ρ≈d(1+[(ζ−x)/d]²/2+[(η−y)/d]²/2). (8)

This approximation simplifies calculating the diffractive wave fields at a sufficiently far distance, resulting in the widely adopted Fresnel propagation model. This can be further simplified when the wave propagates to much larger distances from the hologram aperture, resulting in a far-field Fraunhofer propagation of the wave field.

### Additional Discussion on Light Transport Deviations

In this section, we present additional details on the deviation from ideal coherent light transport in real-world experimental setups.

### SLM Discretization and Fill Factor

Unlike a continuous aperture assumed by scalar diffraction integral, an SLM is discretized into pixels. For a fill factor of 100% of the SLM, the pixel size equals the pixel pitch and the SLM would act as a continuous aperture, although that is often not the case. A real SLM can be characterized by the number of pixels N and M with the pixel pitches Δζ and Δη, and the fill factors α, β ∈ [0,1] in the ζ and η directions respectively. The transmittance of such an SLM can be modeled as

$${t}_{SLM} = rect ( \frac{ζ}{N Δ ζ} , \frac{η}{M Δ η} ) [ {t}_{a p} + {t}_{ds} ] , \qquad ( 9 )$$

$$where$$

$${t}_{a p} ( ζ , η ) = [ rect ( \frac{ζ}{αΔζ} , \frac{η}{β Δ η} ) * comb ( \frac{ζ}{Δ ζ} , \frac{η}{Δ η} ) ] exp ( j Φ ( ζ , η ) ) \qquad ( 10 )$$

is the transmission function of the active pixel area displaying the phase pattern of the computed phase-only hologram H(ζ, η)=exp(jΦ(ζ, η)), and

$${t}_{ds} ( ζ , η ) = \{ [ rect ( \frac{ζ}{Δ ζ} , \frac{η}{Δ η} ) - rect ( \frac{ζ}{αΔζ} , \frac{η}{β Δ η} ) ] * comb ( \frac{ζ}{Δ ζ} , \frac{η}{Δ η} ) \} {A}_{ds} ( ζ , η ) exp ( j {ϕ}_{ds} ( ζ , η ) ) \qquad ( 11 )$$

is the transmission of the dead space area of the SLM pixels, with A_{ds}(ζ, η) and ϕ(ζ, η) denoting the amplitude and phase modulations of the dead space areas, respectively. The terms

$$rect ( \frac{ζ}{αΔζ} , \frac{η}{β Δ η} )$$

represents the active area of a single pixel of the SLM, and the convolution with comb-function

$$comb ( \frac{ζ}{Δ ζ} , \frac{η}{Δ η} )$$

represents the periodic appearance of the pixels in ζ and η directions. The whole SLM is of size NΔζ×MΔη that is expressed by the function

$$rect ( \frac{ζ}{N Δ ζ} , \frac{η}{M Δ η} ) .$$

From Eq. 9, it can be seen that the SLM introduces an extra complex amplitude to the hologram, which typically shows up as a zero-order intensity overlay, significantly distorting the reconstructed image pattern.

### Phase Optimization and Wirtinger Derivatives

As discussed above, we aim for compensating errors in real holographic projections occurring due to aberrations in the hardware display. To this end, we model the real-world deviations from the ideal coherent light transport via a deep neural network that is trained with a large number of real measured holographic projections. Once trained, this deep neural network, which we call an aberration approximator, models the aberrations occurring in a real hardware holographic display with respect to the ideal propagated wave. We then compensate for these aberrations in the real display modeled by the aberration approximator, by optimizing for aberration-compensating holographic phase patterns. In this section, we discuss computing the Wirtinger derivatives for the optimization problem discussed in Section 4 above. Briefly, our forward model is as follows: For a given phase hologram H(Φ), we compute an ideal propagated wave field z using a band-limited angular spectrum propagation, as discussed above

z= [symbol] (H(Φ))= [symbol] ⁻¹( [symbol] [H]·G), (12)

where H(Φ)=e^{jΦ} is the complex phase hologram and G is the band-limited ASM transfer function. The intensity image of this ideal propagated wave (I_{ideal}=|z|²) is passed to the aberration approximator ( [symbol] ) to generate the intensity of the aberrated wave field

\tilde{I}= [symbol] (|z|²), (13)

resulting from various real-world deviations, as discussed above. Ideally, we want to compute hologram phase patterns that result in real hardware reconstructions as close to the target intensity as possible. In other words, we want the distance between the real-hardware display output [symbol] (|z|²) produced by the hologram with phase pattern Φ and the target image I to be zero. We pose the holographic phase retrieval problem as the following optimization problem

$${Φ}_{opt} = {min}_{Φ} f ( 𝒟 ( {\vert z \vert}^{2} ) , I ) , \\ = {min}_{Φ} f ( 𝒟 ( {\vert {ℱ}^{- 1} ( ℱ [ H ] ∘ G \vert}^{2} ) , I ) , \\ = {min}_{Φ} \underbrace{f ( \tilde{I} , I )} \\ Err ( Φ ) \qquad ( 14 )$$

where f is a penalty function to compute the error between the target and reconstructed images. We build on the Wirtinger holography framework to solve the above optimization problem using first-order optimization methods. We briefly discuss here the Wirtinger gradients for our proposed optimization method.

### Wirtinger Gradients

In order to update the hologram phase patterns using a gradient descent optimization technique, we require the gradient of the error function in Eq. (14) with respect to the phase pattern Φ. This can be calculated applying the chain rule to Eq. (12) and (14) as

$$\frac{d ( Err )}{d Φ} = \begin{matrix}\frac{df}{\underbrace{dz}} & \frac{dz}{\underbrace{dH}} & \frac{dH}{\underbrace{d Φ}} \\ A & B & C\end{matrix} . \qquad ( 15 )$$

Notice that Part-A of the Eq. (15) requires us to compute the derivative of the scalar real-valued error f with respect to the complex diffractive wave field z. As the gradient of a scalar valued function with respect to a complex valued variable is zero or not defined, we approximate the partial of the scalar function of the complex vector, to overcome the undefined gradient as

d(Err)=df(z)=Re<∇f, dz>, (16)

where Re denotes the real part of a complex number and <.,.> denotes the inner product of two vectors. Note that the above definition is not the exact gradient but only an approximate definition to use with any first-order optimization techniques. The value of ∇f in the above definition is obtained using the complex Wirtinger derivatives

∇f(z)=2∇_{z̅}f, (17)

which can be further simplified by applying chain rule to Part-A of Eq. (15) as

$${∇}_{\overline{z}} f = [ \frac{df}{d ( 𝒟 ( {\vert z \vert}^{2} ) )} \frac{d ( 𝒟 ( {\vert z \vert}^{2} ) )}{( d {\vert z \vert}^{2} )} ] ∘ 2 {∇}_{\overline{z}} ( {\vert z \vert}^{2} ) . \qquad ( 18 )$$

Observe that the first part of the above Eq. (18) are partials of the scalar error function with respect to the aberrated image, and the partial of the aberrated image from the aberration approximator network with respect to the image from ideal-propagation. The gradients to both can be computed analytically using multivariate calculus, or obtained from the auto-differentiation functionality of the existing deep neural network frameworks. The second part of the Eq. (18) can be reduced to

2∇_{z̅}(|z|²)=2∇_{z̅}(zz̅)=2z. (19)

Therefore, the Part-A of the gradient Eq. (15) is evaluated as follows

$$\frac{df}{dz} = ∇ f = [ \frac{df}{d ( 𝒟 ( {\vert z \vert}^{2} ) )} \frac{d ( 𝒟 ( {\vert z \vert}^{2} ) )}{( d {\vert z \vert}^{2} )} ] ∘ 2 z . \qquad ( 20 )$$

As discussed in Section 1, the ideal wave field at the destination plane can be obtained using an angular spectrum propagation method as z= [symbol] ⁻¹( [symbol] [H]·G), and the image is computed as |z|². Using this model, computing Part-B of the Eq. (15) using the Part-A gradient computed in Eq. (20) yields:

$$\begin{matrix}d ( Err ( H ) ) = Re < ∇ f , dz > , \\ = Re < ∇ f , d ( {F}^{†} ( G ) ( FH ) ) > , \\ = Re < ∇ f , {F}^{†} GFdH > , \\ = Re < {F}^{†} {G}^{†} F ∇ f , dH > , \\ = Re < {F}^{†} {G}^{*} F ∇ f , dH > .\end{matrix} \qquad ( 21 )$$

Finally evaluating Part-C with the complex amplitude on the hologram plane as H=e^{jΦ}, we derive the definition of gradient of the error function with respect to the phase Φ as follows:

$$\begin{matrix}d ( Err ( Φ ) ) = Re < {F}^{†} {G}^{*} F ∇ f , d ( {e}^{j ϕ} ) > , \\ = Re < - j {e}^{- j ϕ} {F}^{†} {G}^{*} F ∇ f , d ( ϕ ) > .\end{matrix} \qquad ( 22 )$$

Since the phase Φ is real valued, the above inner-product definition can be read as:

d(Err(Φ))=<Re(−je^{-jϕ}F^{†}G*F∇f), d(ϕ)>,

∇Err(ϕ)=Re(−je^{-jϕ}F^{†}H*F∇f)l (23)

With the above gradient in hand, we optimize for the aberration-compensating phase patterns using standard first-order stochastic gradient descent solvers.

### Wirtinger Derivatives in Machine Learning Libraries

Popular machine learning libraries such as Tensorflow and PyTorch now support complex valued variables and functions, and include built-in automatic differentiation capability, which was unavailable until recently. We believe that this will greatly facilitate the use of stochastic gradient descent (SGD) methods with complex valued functions for optimization and machine learning, where the user need not specifically derive the complex gradients. In this section, we discuss the complex Wirtinger derivatives and the implementation of automatic differentiation using chain rule in machine learning libraries.

A complex valued function of complex variables which is complex differentiable at every point in its domain is called a holomorphic function. For a given complex function of a complex variable, for instance

f:z ∈ [symbol] f(z)∈ [symbol] (24)

its derivatives can be defined as follows

$${f}^{′} ( {z}_{0} ) = \frac{df}{dz} {\vert}_{{z}_{0}} = {lim}_{z \to {z}_{0}} \frac{f ( z ) - f ( {z}_{0} )}{z - {z}_{0}} . \qquad ( 25 )$$

A given complex function can be decomposed into two real functions, each depending on two real variables, say x and y, which are the real and imaginary parts of the complex variable z. Mathematically, this can be represented as

f(z)=f(x+jy)=u(x, y)+jv(x, y); z=x+jy. (26)

It can be shown that for the above function f(z) to be holomorphic, the corresponding component functions u(x, y) and v(x, y) need to satisfy the Cauchy-Riemann conditions defined as follows:

$$\frac{\partial u ( x , y )}{\partial x} = \frac{\partial v ( x , y )}{\partial y} \qquad ( 27 )$$

$$and$$

$$\frac{\partial v ( x , y )}{\partial x} = - \frac{\partial u ( x , y )}{\partial y} . \qquad ( 28 )$$

This means that if f: [symbol] is a function which is differentiable when regarded as a function on [symbol] ², then f is complex differentiable if and only if the Cauchy-Riemann equations hold. Note that u and v, as defined above, are real-differentiable functions of two real variables and u+iv is a (complex-valued) real-differentiable function. However, u+iv is complex-differentiable if and only if the Cauchy-Riemann equations hold. This insight leads to Wirtinger derivatives of a (complex) function f(z) of a complex variable z=x+jy defined as the following linear partial differential operators of the first order:

$$\frac{\partial f}{\partial z} = \frac{1}{2} ( \frac{\partial f}{\partial x} - j \frac{\partial f}{\partial y} ) \qquad ( 29 )$$

$$and$$

$$\frac{\partial f}{\partial \overline{z}} = \frac{1}{2} ( \frac{\partial f}{\partial x} + j \frac{\partial f}{\partial y} ) . \qquad ( 30 )$$

We refer the reader to Chakravarthula et al.[2019; 2020] for a detailed discussion.

### Chain Rule

With the above defined Wirtinger derivatives, the gradients of compound functions can be computed using chain rule. If f, g ∈ C(Ω), and g(Ω)⊆ Ω, then the derivative of the function f·g can be computed as:

$$\frac{\partial }{\partial z} ( f ∘ g ) = ( \frac{\partial f}{\partial z} ∘ g ) \frac{\partial g}{\partial z} + ( \frac{\partial f}{\partial \overline{z}} ∘ g ) \frac{\partial \overline{g}}{\partial z} \qquad ( 31 )$$

$$and$$

$$\frac{\partial }{\partial \overline{z}} ( f ∘ g ) = ( \frac{\partial f}{\partial z} ∘ g ) \frac{\partial g}{\partial \overline{z}} + ( \frac{\partial f}{\partial \overline{z}} ∘ g ) \frac{\partial \overline{g}}{\partial \overline{z}} . \qquad ( 32 )$$

While the above definition can be used to compute the complex gradients, such as in Tensorflow's library, one can also formulate the partial derivatives as forming the components of the Jacobian matrix. The derivative then can be expressed as a matrix representation of the following relation:

D(f·g)=(Df·g)Dg (33)

where the Jacobian on f, Df, is defined as:

$$Df = ( \begin{matrix}\frac{\partial f}{\partial z} \\ \frac{\partial \overline{f}}{\partial z}\end{matrix} \begin{matrix}\frac{\partial f}{\partial \overline{z}} \\ \frac{\partial \overline{f}}{\partial \overline{z}}\end{matrix} ) . \qquad ( 34 )$$

Now, for a function f(x, y)=(u(x, y),v(x, y)), we can express the above Equation (34) in the frame of

$$\frac{\partial }{\partial x} and \frac{\partial }{\partial y}$$

as the matrix

$$Jf = ( \begin{matrix}\frac{\partial u}{\partial x} \\ \frac{\partial v}{\partial x}\end{matrix} \begin{matrix}\frac{\partial u}{\partial y} \\ \frac{\partial v}{\partial y}\end{matrix} ) \qquad ( 35 )$$

along with the base change matrix, to change the basis to

$$\frac{\partial }{\partial z} and \frac{\partial }{\partial \overline{z}} ,$$

given by

$$P = \frac{1}{2} ( \begin{matrix}1 & - i \\ 1 & i\end{matrix} ) . \qquad ( 36 )$$

Following the Wirtinger derivatives defined in Equations (29) and (30), the Jacobian operation Df in the

$$\frac{\partial }{\partial z} , \frac{\partial }{\partial \overline{z}}$$

frame can now be expressed as P Jf P⁻¹. This formulation of complex gradients is used in the PyTorch implementation of auto-gradients. For non-holomorphic functions, whose gradients are either zero or not defined, both machine learning libraries give a descent direction.

### Additional Prototype Details

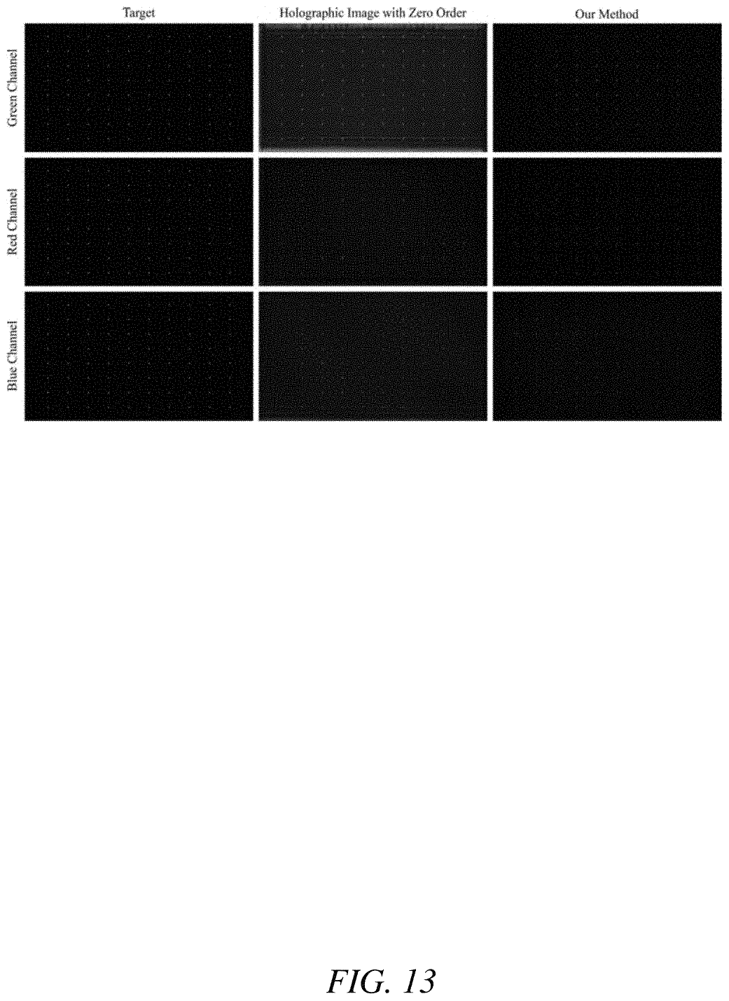

Our hardware prototype is similar to the one demonstrated by Chakravarthula et al. Our bench-top prototype is built using cage system mounting and the optics are adjusted for an image plane distance of about 200 mm from the SLM. We use red, green, and blue single-mode fiber lasers that are controlled by a Thorlabs LDC205C Laser Diode Controller, sequentially changing the three colors. The exposure of the imaging camera and the laser intensity are adjusted once based on the laser power. All capture settings are kept constant for experiments. The holographic image is directly mapped on the camera sensor. We use an additional phase ramp over the holograms to shift the image away from the zero-order undiffracted light. However, this makes the conjugate (ghost) images apparent. We filter both the zero-order and the conjugate images using an iris in the intermediate plane. Although this causes additional artifacts due to the SLM limitations, we are able to correct for those aberrations using our hardware-in-the-loop phase retrieval method. The improved contrast due to the zero-order elimination can be seen in FIG. 13.

### Additional Experimental Validation

### Additional Experimental Captures

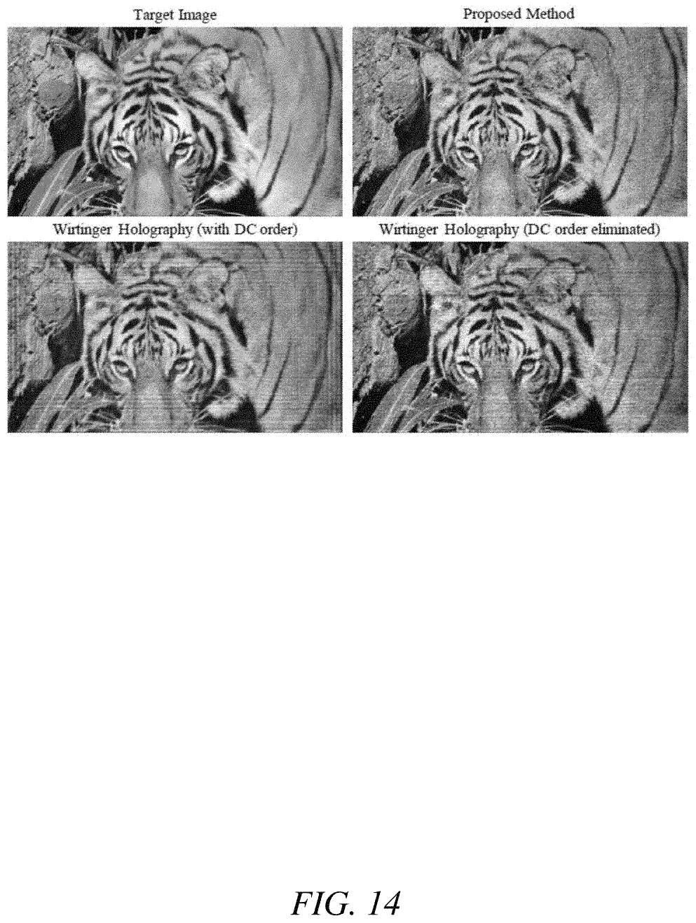

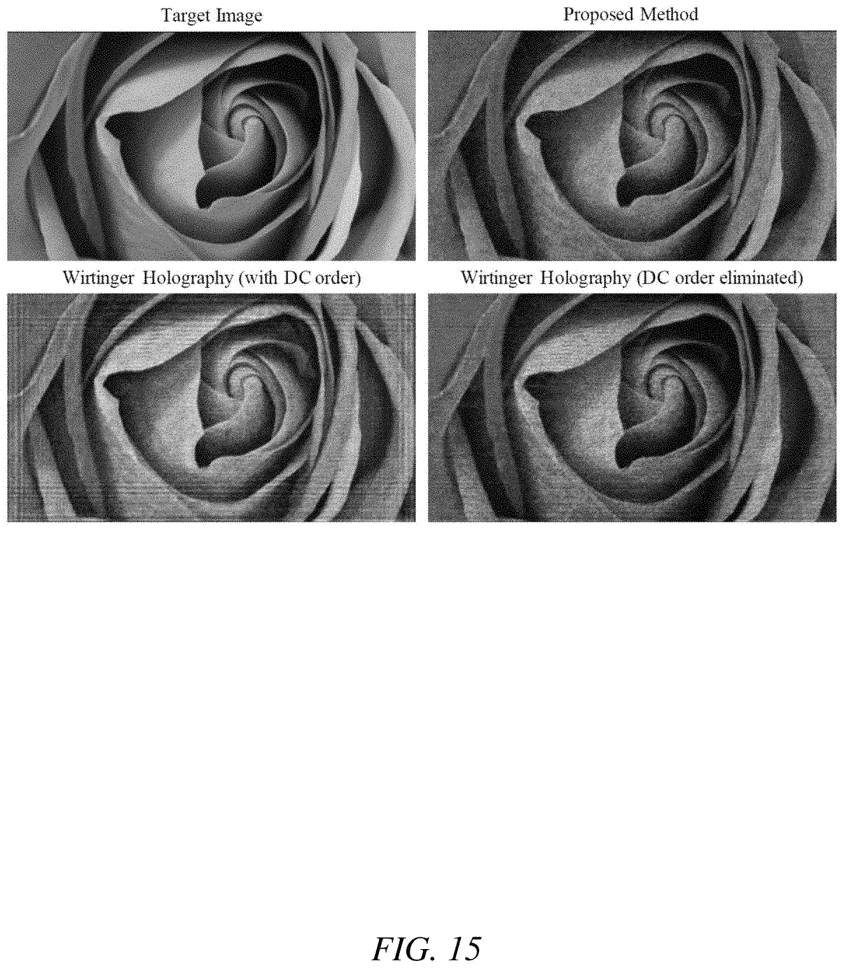

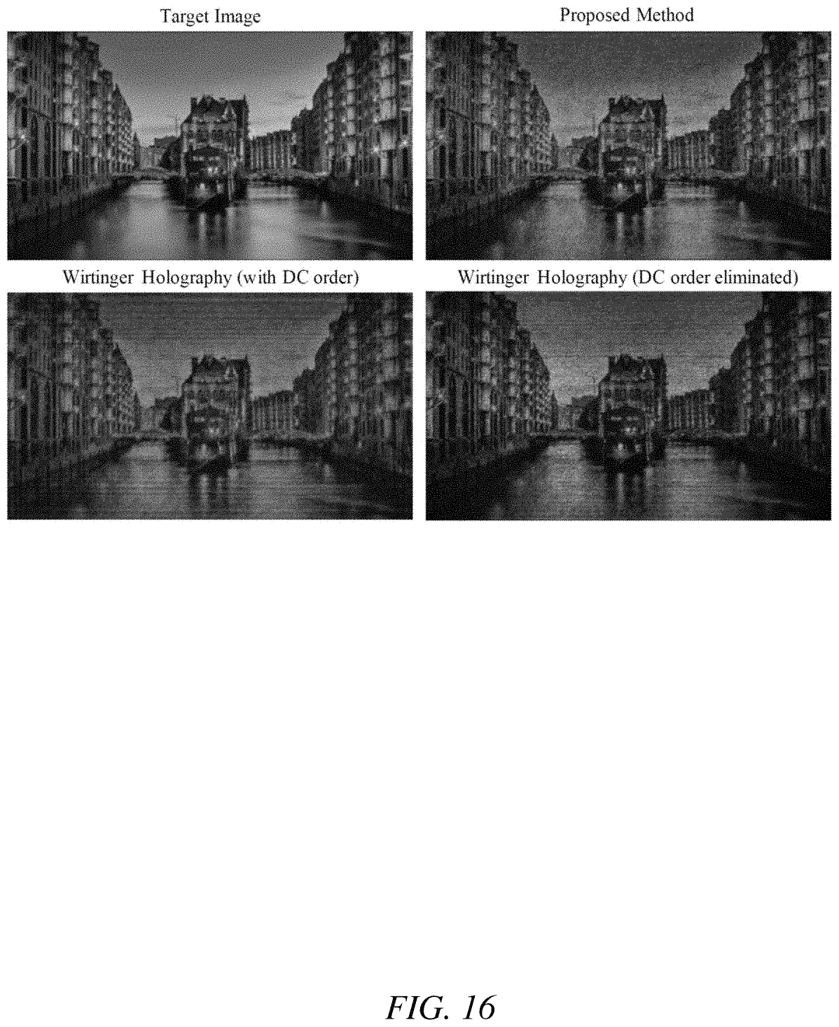

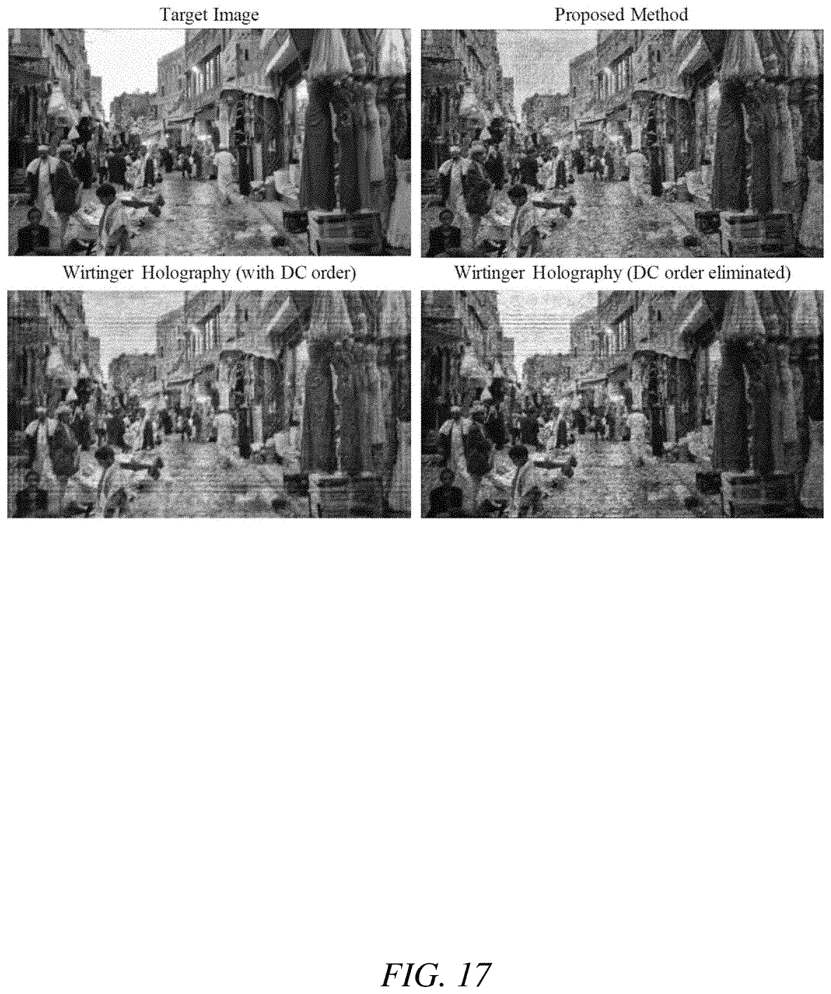

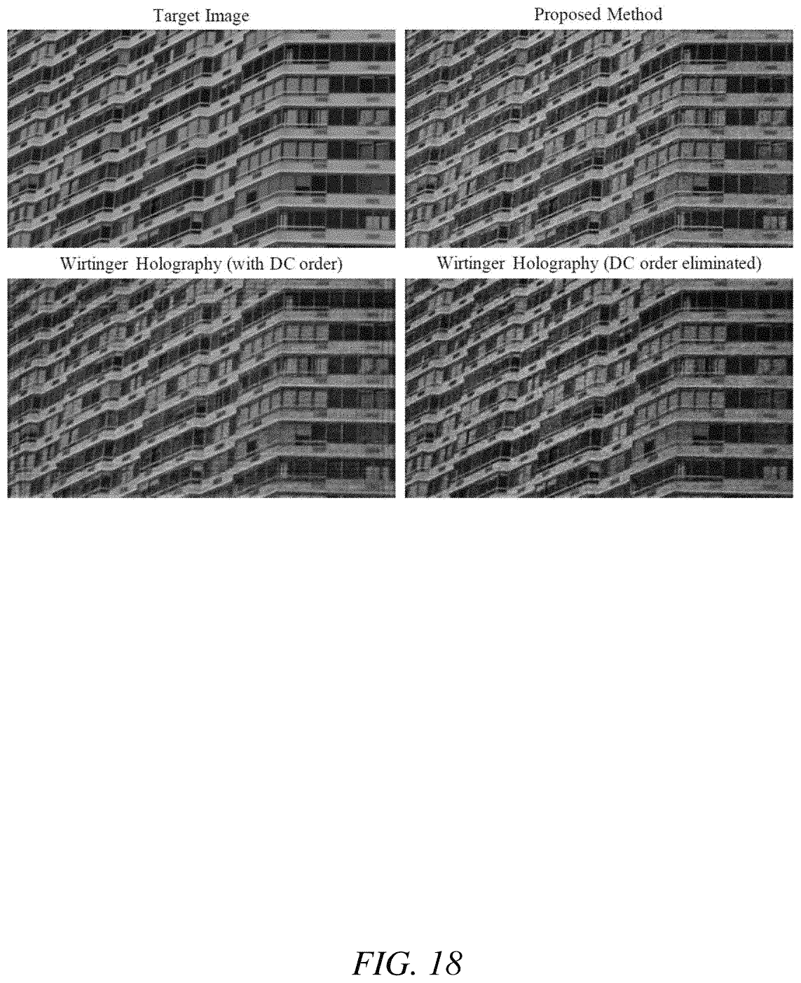

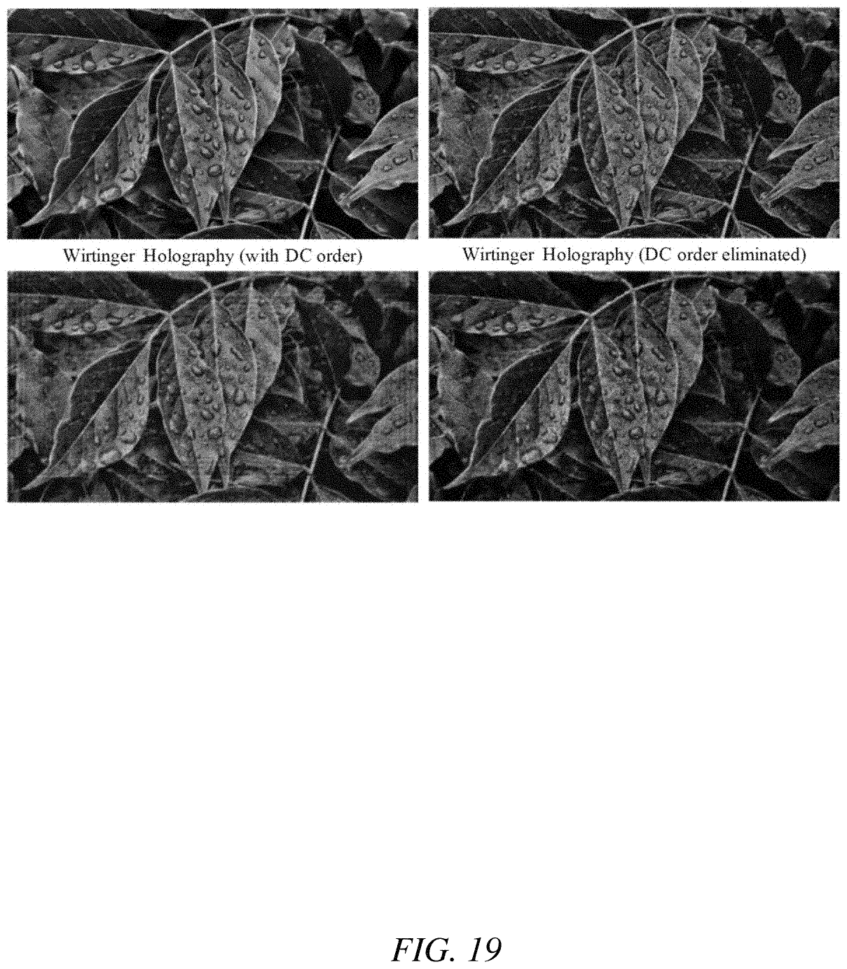

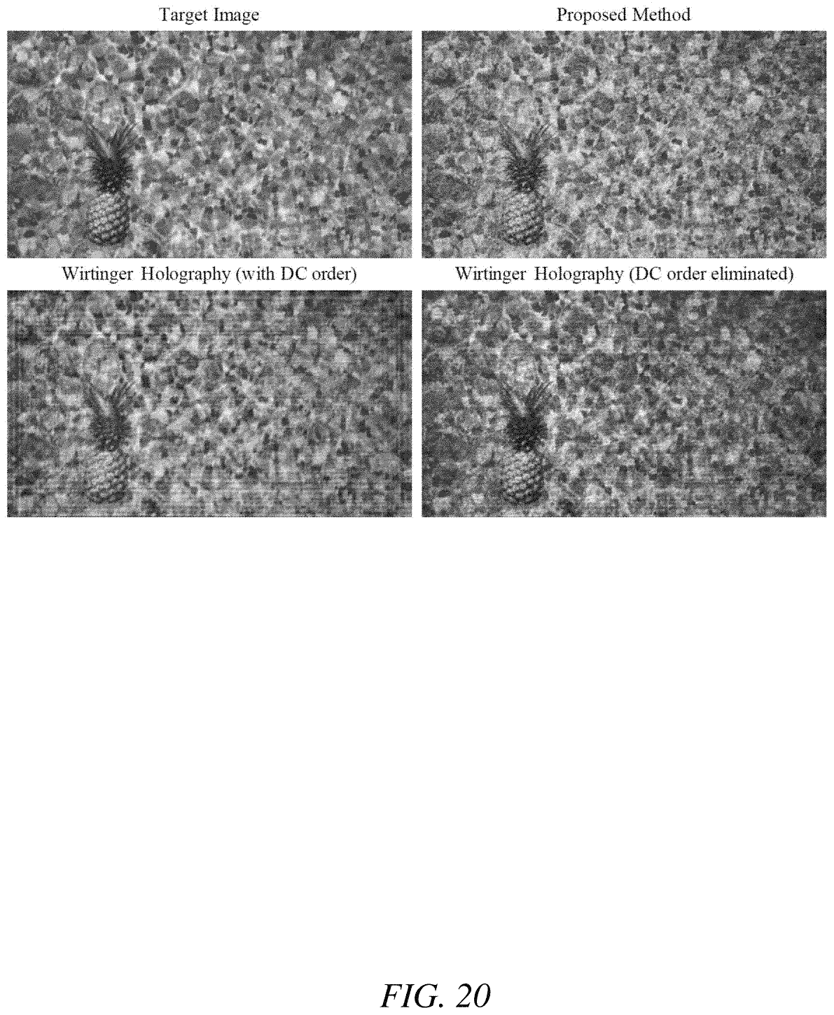

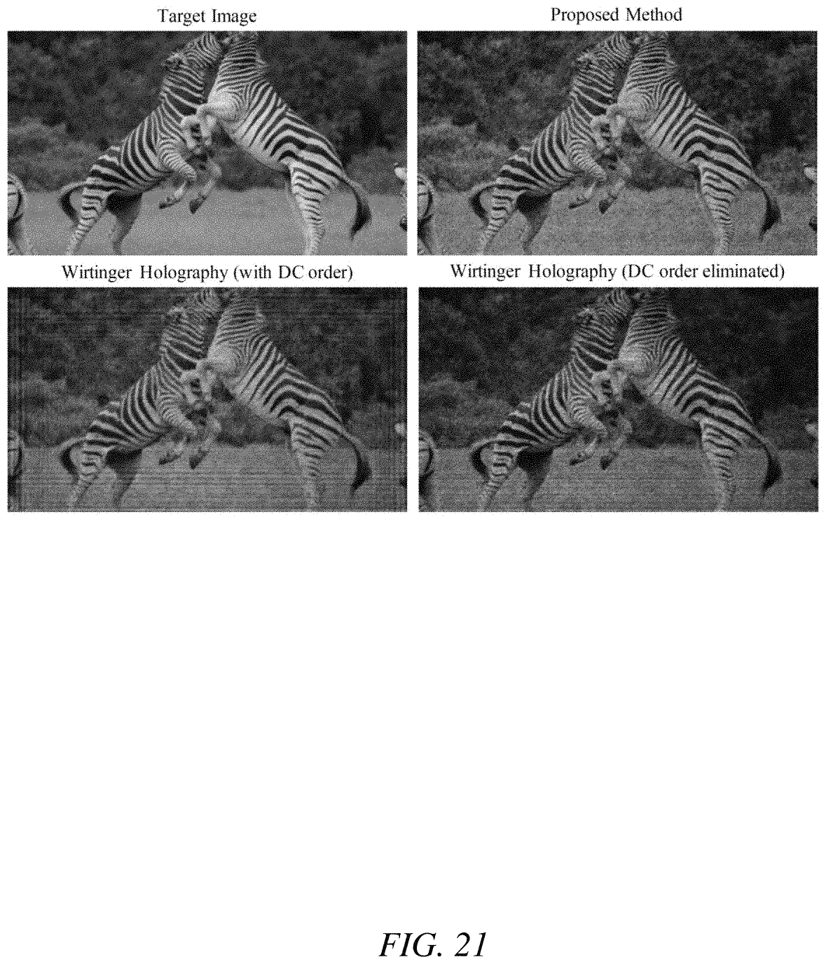

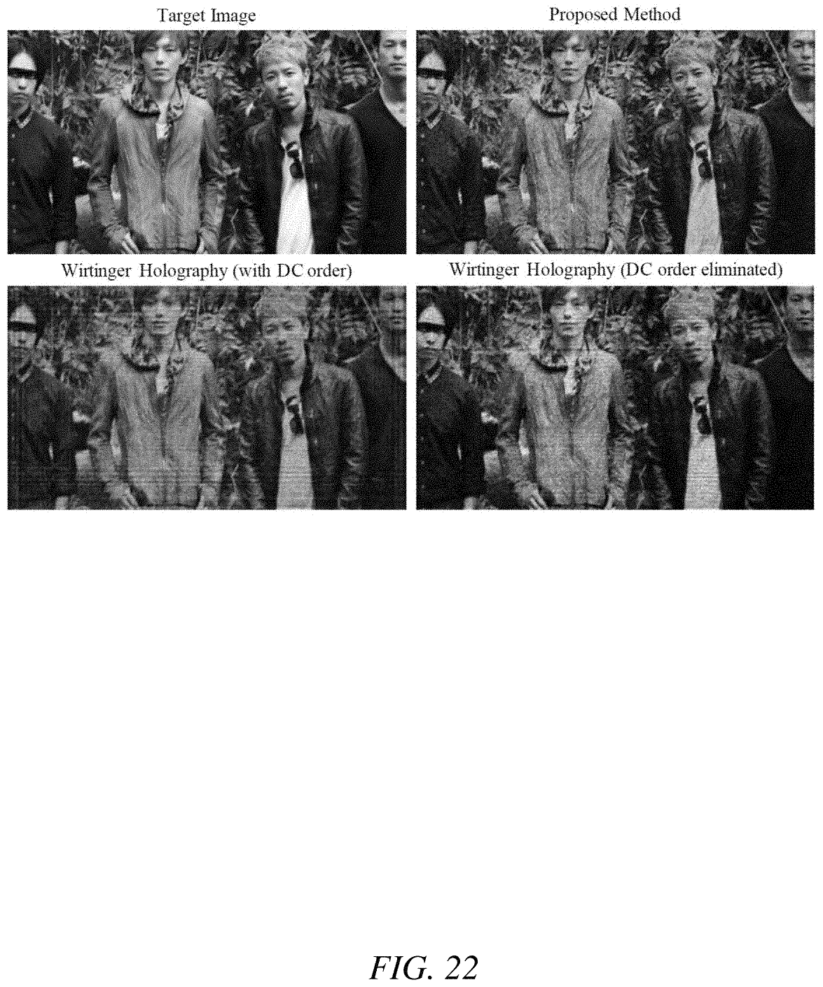

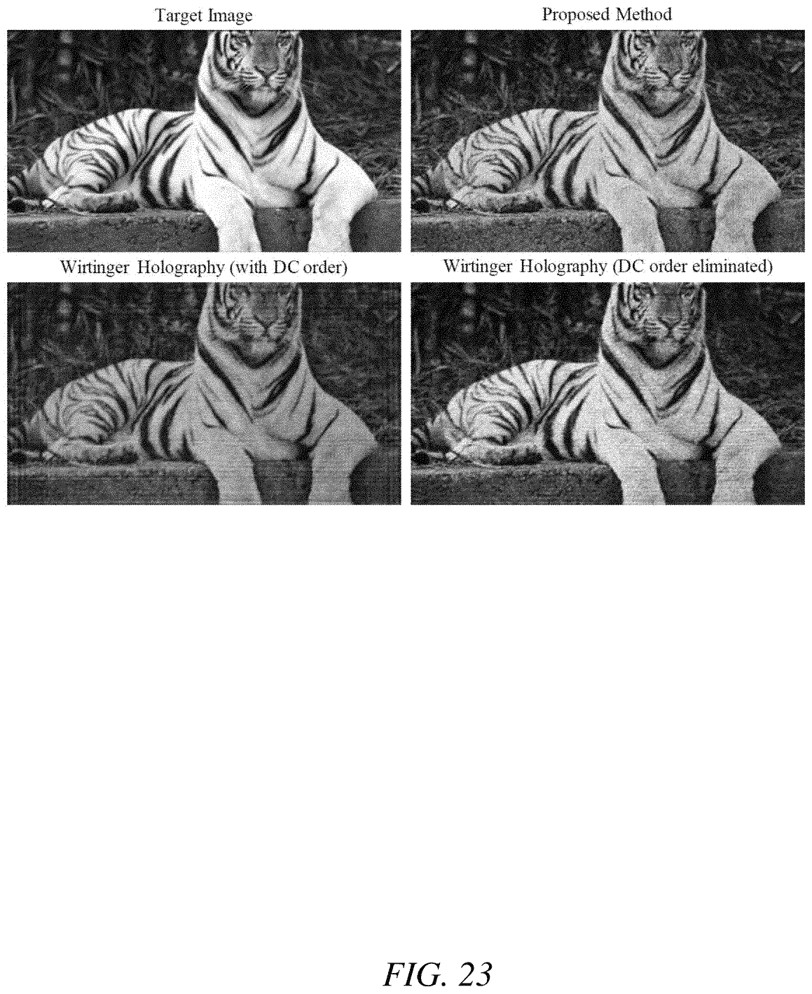

We found that the proposed method consistently outperforms existing phase retrieval methods across several test scenes. Wirtinger holography with DC order introduces undesirable ringing artifacts along the borders of the image. Wirtinger holography without the DC order mitigates this artifact but in doing so it produces severe granular noise across the image alongside global artifacts such as horizontal and vertical streaks which can be seen across images. Our proposed phase retrieval method effectively reduces the laser speckle to a finer resolution with a lighter intensity. Furthermore, it minimizes the impact of other forms of aberrations such as the aforementioned horizontal and vertical streaks. FIGS. 14-23 showcase holographic display captures from each of these phase retrieval methods and affirm these observations.

### Additional 3D Holographic Display Results

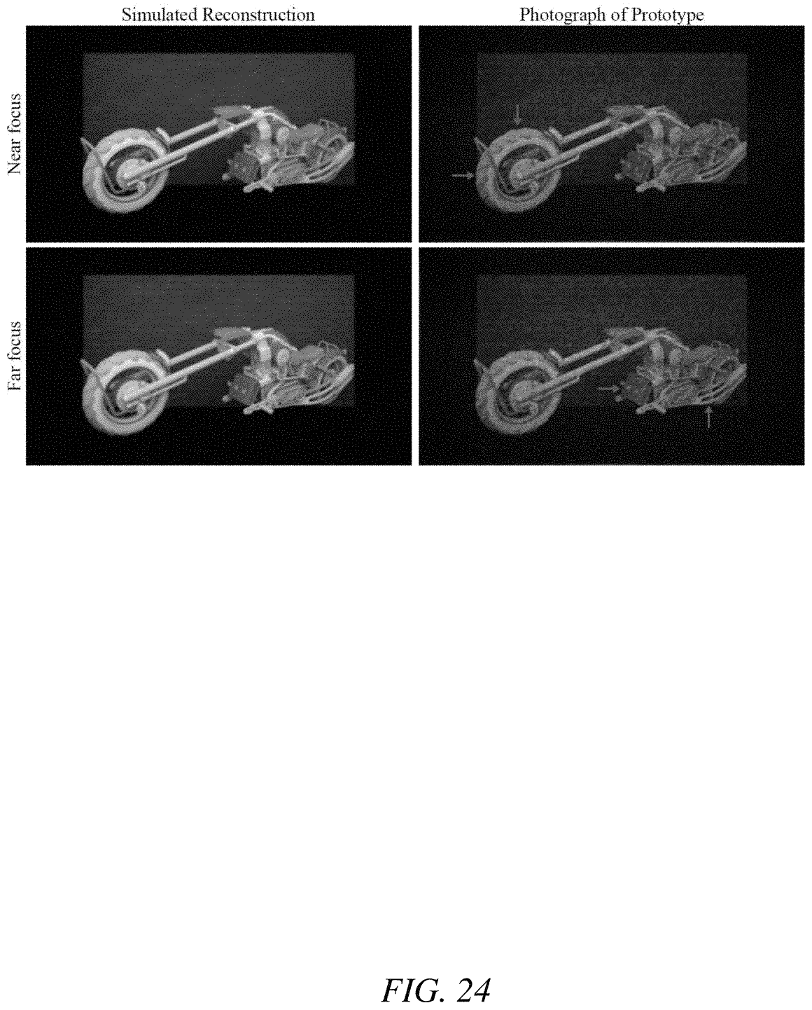

We demonstrate that the proposed hardware-in-the-loop optimization can be naturally extended to optimizing 3D holographic displays. We do this by applying the proposed method to a stack of 2D slices of a 3D volume. Note that the aberration approximator was not trained on these 2D slices but still manages to perform the desired task. Qualitative results are shown in FIG. 9 and FIG. 24. The proposed method reduces the holographic aberrations and allows for fine details to be seen at both near and far focus.

### Online-Camera Phase Optimization

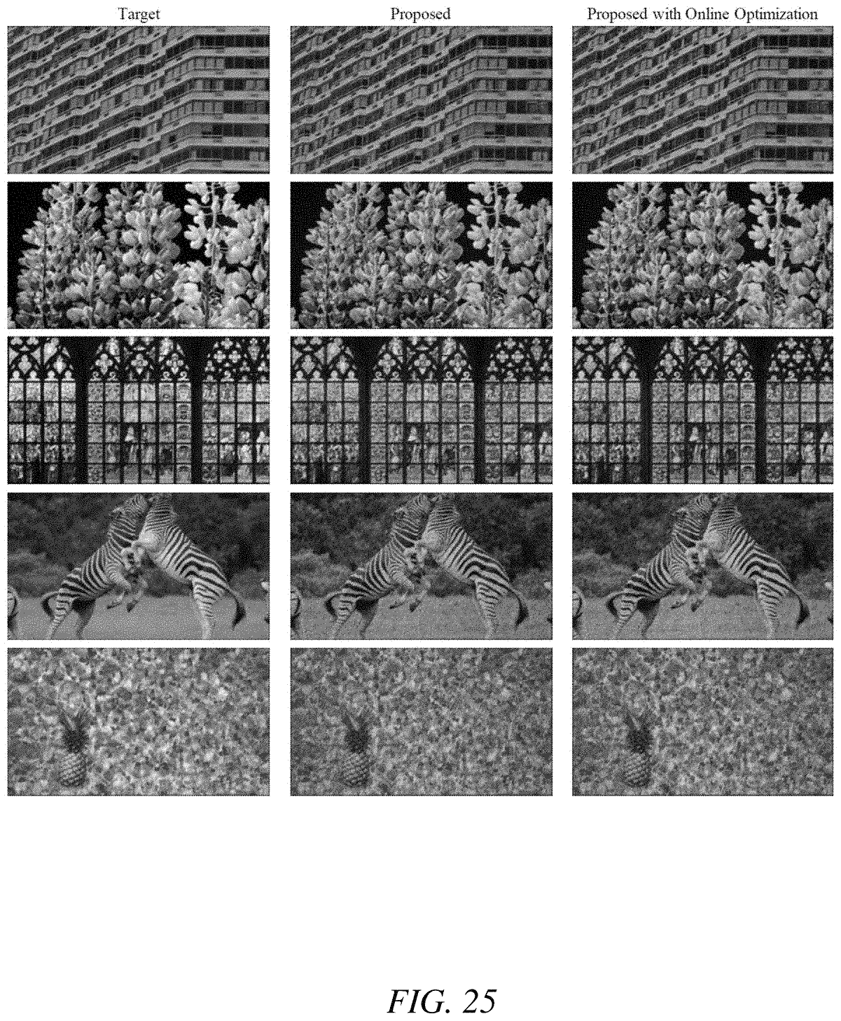

We extend the proposed hardware-in-the-loop phase retrieval to an online-camera based optimization framework where new images acquired at each iteration are used for refining the aberration compensating phase holograms. Note that unlike the default hardware-in-the-loop framework, we are now separately refining an aberration approximator for each individual test image. Prototype results using this online optimization are shown in FIG. 25. Although applying phase optimization with an active online-camera for each image frame produces improved holographic projections, our learned aberration approximator compensates for most aberrations after just a single refinement iteration and without having observed the test images as discussed above, thereby eliminating the need for additional refinement through online phase optimization.

### Additional Analysis

### Initialization and Termination Criteria

Here we discuss the initialization and termination criteria for our hardware-in-the-loop phase retrieval framework.

To solve the optimization as described in Algorithm 1 above, we start the optimization process with an initial guess of the phase value and the aberration approximation to be the identity function. We then alternate between the following two procedures for K iterations.
1. We train the aberration approximator neural network to map phase holograms (assuming no aberrations) to holographic images as captured from the real hardware. Neural network training is done for 40000 steps.
2. After training, we freeze the aberration approximator and use it to optimize for a new set of holograms that refine the errors produced by the phase holograms in the previous iteration. The optimization of aberration compensating phase holograms is terminated when the 1-LPIPS score surpasses 0.5 to ensure good perceptual quality of the final holographic display outputs.
   We empirically find that running Algorithm 1 for K=1 iterations already compensates for many aberrations.

### Additional Details for Aberration Approximator Network

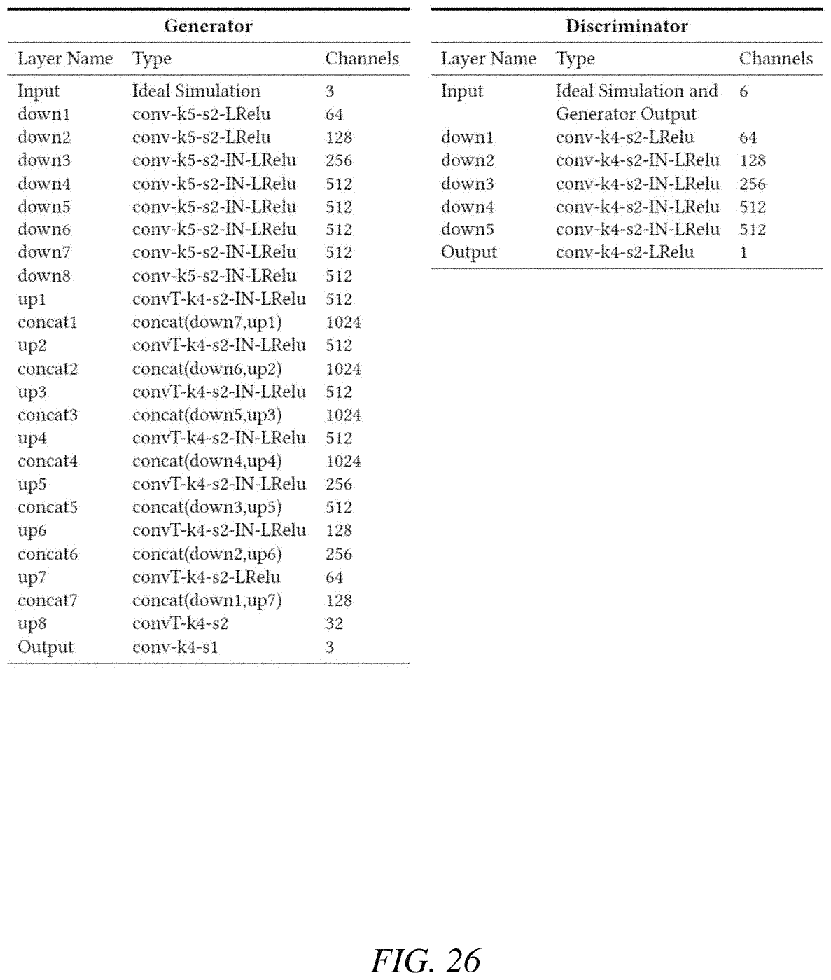

Our generator and discriminator architectures are shown in FIG. 26. As described above, our generator architecture is a variant of the U-Net with modifications that significantly improve its ability to learn the holographic aberrations. Our architecture design choices aim to allow the generator network to better learn the fine grained aberration details and color tones observed in the holographic captures.

Departing from the popular Pix2Pix generator architecture, we removed dropout which we found caused excessive regularization. We then added an additional convolution layer at the original 1080×1920 resolution with the aim of allowing finer details to be reproduced. Since we use single-batch training, we use instance normalization instead of batch normalization. We removed instance normalization from the first two encoding layers and last two decoding layers. Since instance normalization is to reduce the effects of image contrast, we removed it from the higher resolution layers to allow the network to better learn color tones, but kept them at the lower resolution layers to facilitate network training. The discriminator architecture is a 94×94 PatchGAN. We deviate from traditional conditional GANs by conditioning our discriminator on the ideal simulated reconstruction instead of a semantic guide such as a segmentation map. For our perceptual loss we used the VGG-19 network with weights from the following source: https://www.kaggle.com/teksab/imagenetvggverydeep19mat.

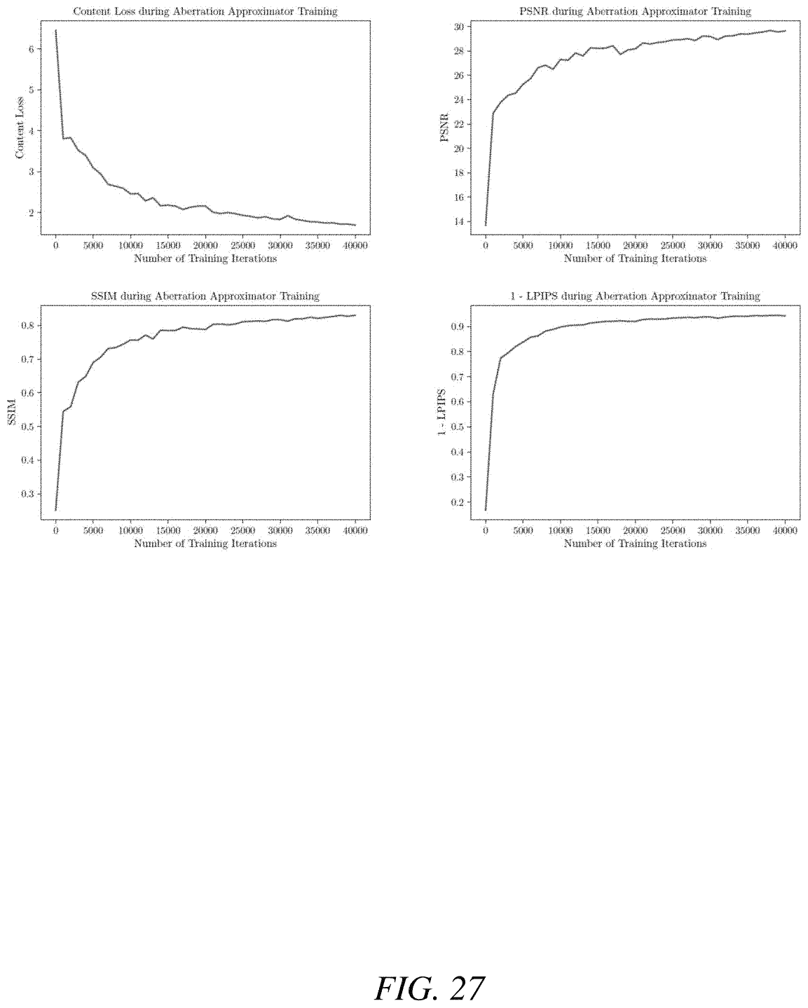

We trained our network for 40000 iterations using the Adam optimizer and found training to be stable and that the network converged to a good point for aberration prediction. See FIG. 27 for the training plots showing convergence of the proposed content loss, PSNR, SSIM, and 1-LPIPS over the training period.

### Baseline Comparisons

For our comparisons against alternative deep learning methods we used the following experimental setup. For Pix2Pix and Pix2PixHD we use their code with the default settings and train for 40000 iterations. For the U-Net comparisons we train for 40000 iterations using the Adam optimizer with learning rate 0.0002 and β₁=0.5 and β₂=0.999, and we use the same architecture as described in Ronneberger et al. except with half the number of filters at each layer due to memory constraints. For Pix2PixHD we use the default settings for their network architectures and loss functions except that we reduce the number of filters in the first layer of the generator and discriminator from 64 to 32 due to memory constraints.

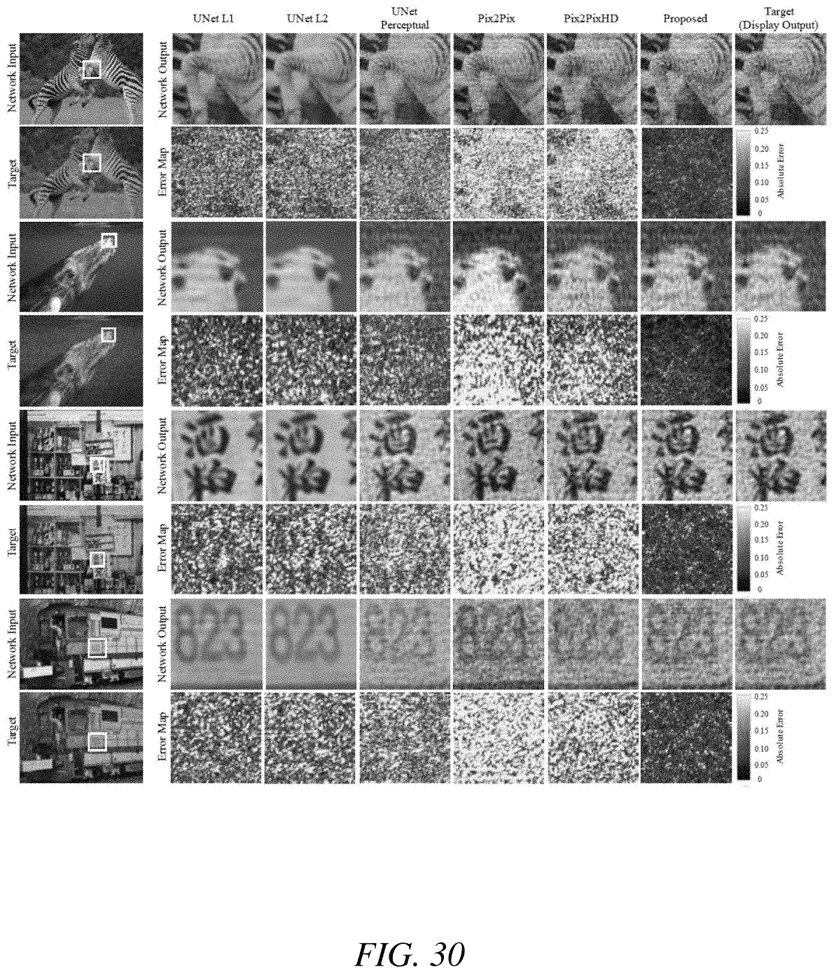

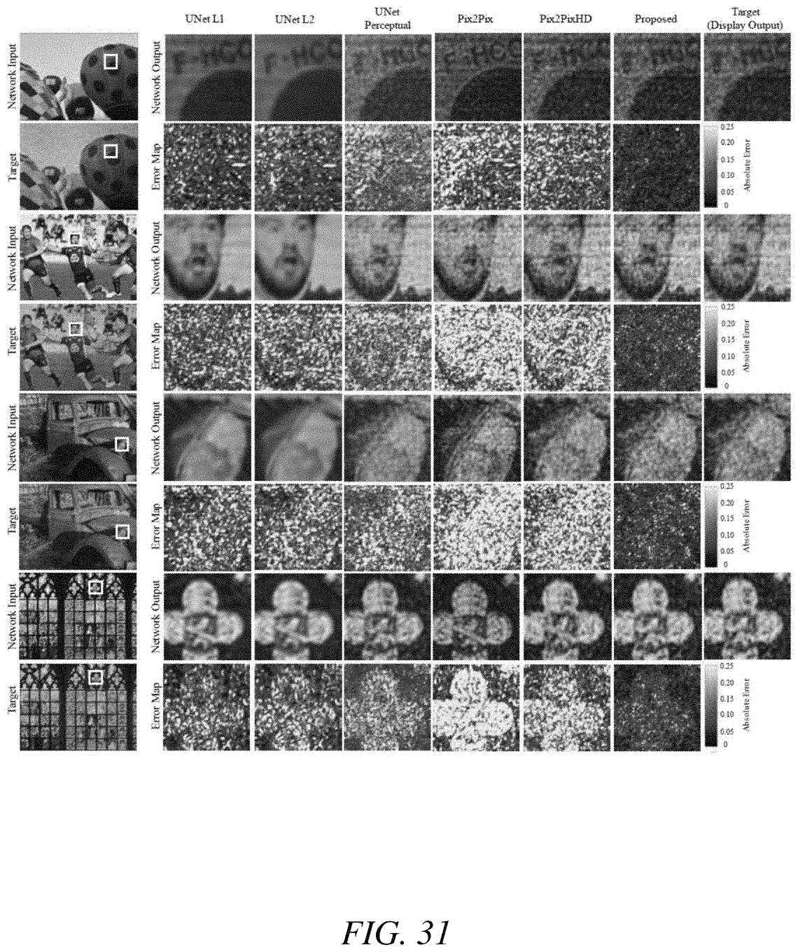

In addition to FIG. 6, FIGS. 30 and 31 show additional comparison examples. We again see that the U-Net methods are unable to capture the aberration details. Although Pix2Pix and Pix2PixHD produce believable aberrations, the error maps show a large mismatch between their network predictions and the actual target display.

Overall, we found that using these methods out-of-the-box did not work for our task of predicting fine aberration details in the holographic captures. As such, we proposed the network and loss function described above towards the desired task. The ablation study described above and in the following section further validates our design choices.

### Ablation Study

We demonstrate the importance of our network architecture and loss function through our ablation study, see Table 1 for quantitative results. We found that careful adjustments were necessary when designing the aberration approximator architecture and loss function. Although the proposed network is capable of outputting high fidelity aberration predictions, we found that a good loss function design was necessary to avoid bad local minima.

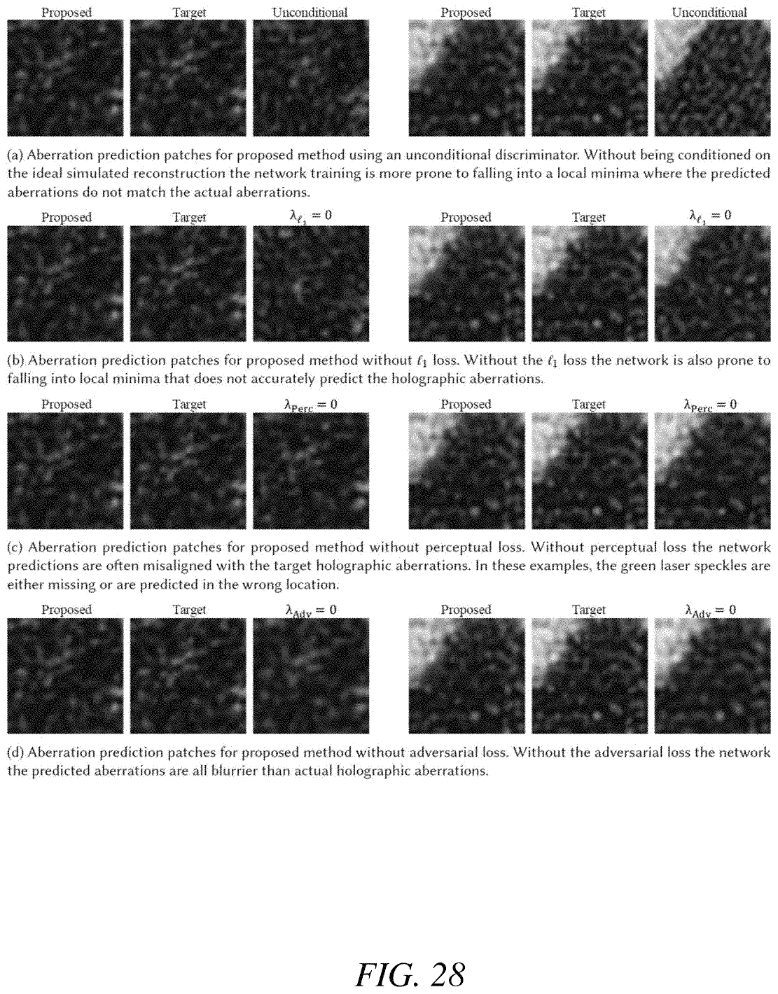

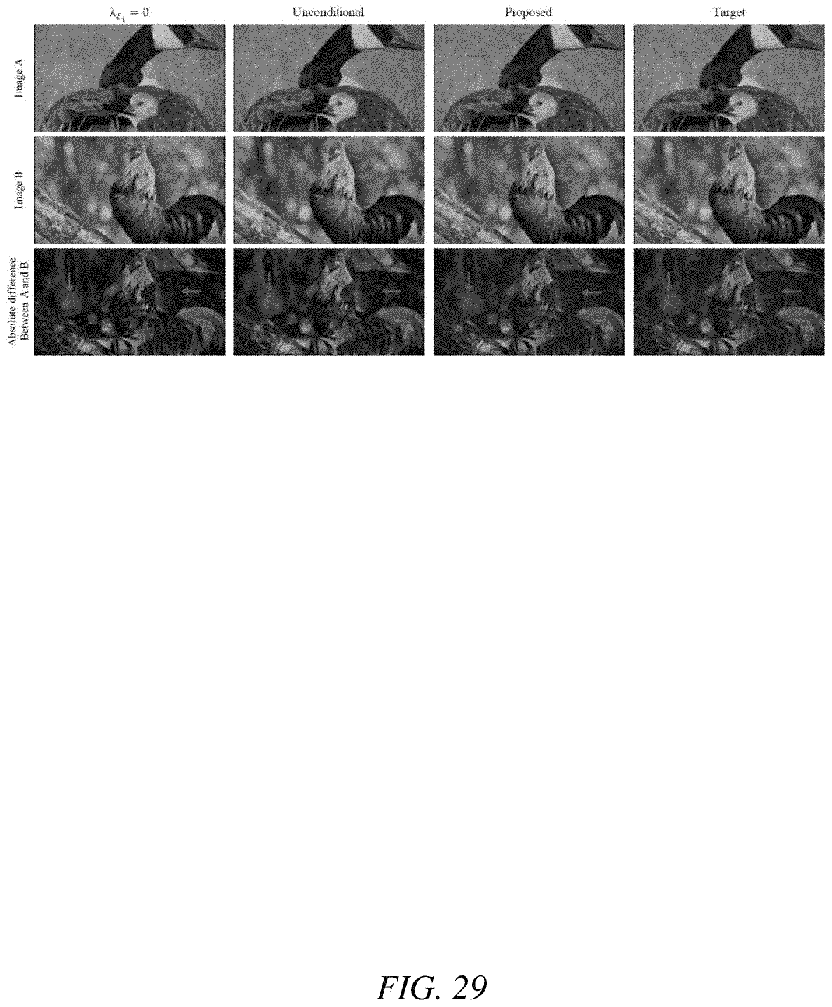

Specifically, we found that using an unconditional GAN or setting λₗ_{₁}=0 caused the network to converge on a minima where the predicted aberration pattern is almost the same across images, see FIG. 29 for qualitative examples. See also FIG. 28, rows (a) and (b) for examples of the mismatch between the predicted aberration and the actual holographic display.

We found that using a combination of l₁ loss and a conditional GAN avoided this local minima. When only using l₁ and perceptual loss we found that the predicted aberration patterns had a slight blur to them, see FIG. 28, row (c). On the other hand, using only l₁ and adversarial loss produced aberration predictions that look accurate at first glance, but upon closer observation the laser speckle patterns are often mismatched with the target, see FIG. 28, row (d). Note that, although the PSNR increases in Table 1 when λ_{Perc}=0 or λ_{Adv}=0, these observable inaccuracies indeed correspond with a lower 1-LPIPS score. Since LPIPS has been shown by Zhang et al. to be a better measure of perceivable quality than PSNR or SSIM, the proposed design's top LPIPS performance in addition to good PSNR and SSIM performance demonstrates its superiority over the alternatives. As such, the proposed combination of l₁, perceptual, and adversarial loss using a conditional GAN regime provides the best aberration predictions that generalize to unseen images, and this is evidenced by the accuracy of the proposed method when used for hardware-in-the-loop training (Table 2 and Table 3 above).

9.3 Simulated Phase Retrieval with Aberration Approximator

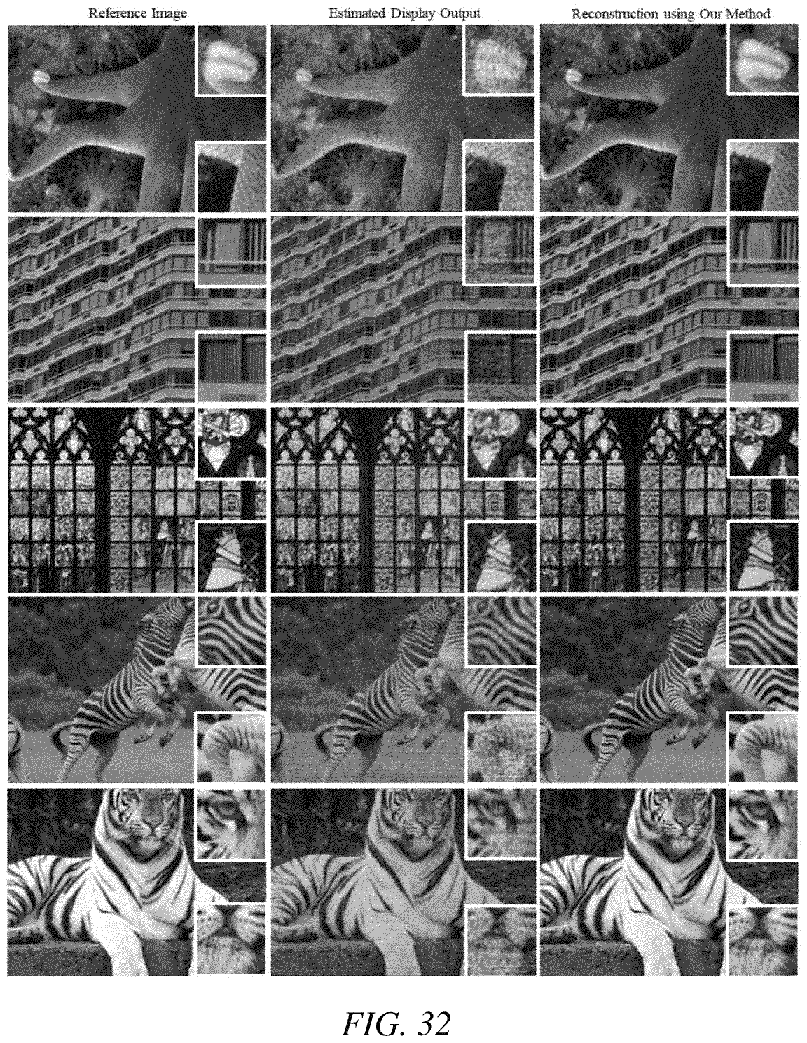

FIG. 32 shows additional simulation results that demonstrate that the aberration approximator allows for effective phase hologram optimization within the Wirtinger framework.

The disclosure of each of the following references is incorporated herein by reference in its entirety.

### REFERENCES

Praneeth Chakravarthula, Yifan Peng, Joel Kollin, Henry Fuchs, and Felix Heide. 2019. Wirtinger holography for near-eye displays. ACM Transactions on Graphics (TOG) 38, 6 (2019), 213.

Praneeth Chakravarthula, Yifan Peng, Joel Kollin, Felix Heide, and Henry Fuchs. 2020. Computing high quality phase-only holograms for holographic displays. In Optical Architectures for Displays and Sensing in Augmented, Virtual, and Mixed Reality (AR, VR, MR), Vol. 11310. International Society for Optics and Photonics, 1131006.

Joseph W Goodman. 2005. Introduction to Fourier optics. Roberts and Company Publishers.

Kyoji Matsushima and Tomoyoshi Shimobaba. 2009. Band-limited angular spectrum method for numerical simulation of free-space propagation in far and near fields. Optics express 17, 22 (2009), 19662-19673.

Reinhold Remmert. 2012. Theory of complex functions. Vol. 122. Springer Science & Business Media.

Olaf Ronneberger, Philipp Fischer, and Thomas Brox. 2015. U-net: Convolutional networks for biomedical image segmentation. In International Conference on Medical image computing and computer-assisted intervention. Springer, 234-241.

Fabin Shen and Anbo Wang. 2006. Fast-Fourier-transform based numerical integration method for the Rayleigh-Sommerfeld diffraction formula. Applied optics 45,6 (2006), 1102-1110.

Dmitry Ulyanov, Andrea Vedaldi, and Victor S. Lempitsky. 2016. Instance Normalization: The Missing Ingredient for Fast Stylization. ArXiv abs/1607.08022 (2016).

Richard Zhang, Phillip Isola, Alexei A Efros, Eli Shechtman, and Oliver Wang. 2018. The unreasonable effectiveness of deep features as a perceptual metric. arXiv preprint (2018).

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for learned hardware-in-the-loop phase retrieval for holographic near-eye displays, the method comprising:
generating simulated ideal output images of a holographic display;
capturing real output images of the holographic display;
learning a mapping between the simulated ideal output images and the real output images;
using the learned mapping to solve for an aberration compensating hologram phase; and
using the aberration compensating hologram phase to adjust a phase pattern of a spatial light modulator of the holographic display.

2. The method of claim 1 wherein generating the simulated ideal output images includes generating simulated ideal output images using a model that assumes ideal light propagation through optics of the holographic display.

3. The method of claim 1 wherein capturing the real output images of the display includes capturing the real output images using a camera.

4. The method of claim 1 wherein learning the mapping between the simulated ideal output images and the real output images includes training an aberration approximator to learn the mapping.

5. The method of claim 1 wherein using the learned mapping to solve for the aberration compensating hologram phase includes using the learned mapping as a substitute for real display and camera hardware to compute holograms to compensate for aberrations caused by the real display and camera hardware.

6. The method of claim 1 wherein using the learned mapping to solve for the aberration compensating hologram phase includes using the learned mapping in an online mode to adjust the phase pattern based on an output image currently being displayed by the holographic display.

7. A system for learned hardware-in-the-loop phase retrieval for holographic near-eye displays, the system comprising:
a holographic display including a light source and a configurable spatial light modulator (SLM);
an ideal output image generator for generating simulated ideal output images of the holographic display;
a camera for capturing real output images of the holographic display;
a neural network for learning a mapping between the simulated ideal output images and the real output images;
a hologram calculator for using the learned mapping to solve for an aberration compensating hologram phase; and
an SLM controller for using the aberration compensating hologram phase to adjust a phase pattern of the spatial light modulator.

8. The system of claim 7 wherein generating the simulated ideal output images includes generating simulated ideal output images using a model that assumes ideal light propagation through optics of the holographic display.

9. The system of claim 7 wherein learning the mapping between the simulated ideal output images and the real output images includes training an aberration approximator to learn the mapping.

10. The system of claim 7 wherein using the learned mapping to solve for the aberration compensating hologram phase includes using the mapping learned by the aberration approximator as a substitute for real display and camera hardware to compute holograms to compensate for aberrations caused by the real display and camera hardware.

11. The system of claim 7 wherein using the learned mapping to solve for the aberration compensating hologram phase includes using the learned mapping in an online mode to adjust the phase pattern based on an output image currently being displayed by the holographic display.

12. A non-transitory computer readable medium having stored thereon executable instructions that when executed by a processor of a computer control the computer to perform steps comprising:
generating simulated ideal output images of a holographic display;
capturing real output images of the holographic display;
learning a mapping between the simulated ideal output images and the real output images;
using the learned mapping to solve for an aberration compensating hologram phase; and
using the aberration compensating hologram phase to adjust a phase pattern of a spatial light modulator of the holographic display.

13. The non-transitory computer readable medium of claim 12 wherein generating the simulated ideal output images includes generating simulated ideal output images using a model that assumes ideal light propagation through optics of the holographic display.

14. The non-transitory computer readable medium of claim 12 wherein capturing the real output images of the display includes capturing the real output images using a camera.

15. The non-transitory computer readable medium of claim 12 wherein learning the mapping between the simulated ideal output images and the real output images includes training an aberration approximator to learn the mapping.

16. The non-transitory computer readable medium of claim 12 wherein using the learned mapping to solve for the aberration compensating hologram phase includes using the mapping learned by the aberration approximator as a substitute for real display and camera hardware to compute holograms to compensate for aberrations caused by the real display and camera hardware.

17. The non-transitory computer readable medium of claim 12 wherein using the learned mapping to solve for the aberration compensating hologram phase includes using the learned mapping in an online mode to adjust the phase pattern based on an output image currently being displayed by the holographic display.
